(19) United States
(12) Patent Application Publication
(10) Pub. No.: US 2022/0352734 A1
(43) Pub. Date: Nov. 3, 2022

(54) WORK CART CHARGING

(71) Applicant: MILWAUKEE ELECTRIC TOOL CORPORATION, Brookfield, WI (US)

(72) Inventors: Isabel M. Lloyd, West Allis, WI (US); Kevin D. White, Milwaukee, WI (US); Christopher S. Spaulding, Green Bay, WI (US); Shreyas Sridar, Milwaukee, WI (US); Kyle Reeder, Waukesha, WI (US); Caroline G. Fox, Richfield, WI (US); Matthew N. Thurin, Richfield, WI (US); Gareth Mueckl, Milwaukee, WI (US); Matthew Post, Milwaukee, WI (US); Colin J. Roberts, Brookfield, WI (US)

(21) Appl. No.: 17/733,316

(22) Filed: Apr. 29, 2022

Related U.S. Application Data
(60) Provisional application No. 63/325,990, filed on Mar. 31, 2022.
(60) Provisional application No. 63/181,687, filed on Apr. 29, 2021.

(51) Int. Cl. H02J 7/00; F21L 4/08

(52) U.S. Cl. CPC H02J 7/0045; H02J 7/0042; H02J 7/00047; F21L 4/08

(57) ABSTRACT

A charging module is configured to be removably coupled to a mobile work cart. The charging module includes a housing having a first end, a second end, a front side, and a rear side. The housing defines a cavity in the front side and includes a charging bay located within the cavity. The charging bay is configured to removably receive a battery pack to electrically connect the battery pack to the charging module. The charging module also includes a clamp coupled to the rear side of the housing. The clamp includes a handle portion and an arm. The clamp is movable relative to the housing between a deployed position and a retracted position. The clamp is biased toward the retracted position. The housing defines a recess in the rear side. When the clamp is in the retracted position the arm is received within the recess.

### CROSS-REFERENCE TO RELATED APPLICATIONS

This application claims priority to co-pending U.S. Provisional Patent Application No. 63/181,687, filed Apr. 29, 2021, and to co-pending U.S. Provisional Patent Application No. 63/325,990, filed Mar. 31, 2022, the entire content of each of which is hereby incorporated by reference.

### TECHNICAL FIELD

The present disclosure relates generally to work cart charging systems, devices, and related methods.

### BACKGROUND

Battery packs can supply power to electrical devices. When battery packs become depleted, charging systems can re-charge the battery packs.

### SUMMARY

The present disclosure provides, in one aspect, a charging module configured to be removably coupled to a mobile work cart. The charging module includes a housing having a first end, a second end opposite the first end, a front side, and a rear side opposite the front side. The housing defines a cavity in at least the front side. The housing includes a charging bay located within the cavity. The charging bay is configured to removably receive a battery pack to electrically connect the battery pack to the charging module. The charging module also includes a clamp coupled to the rear side of the housing. The clamp includes a handle portion and an arm. The clamp is movable relative to the housing along a direction toward or away from the rear side between a deployed position and a retracted position. The clamp is biased toward the retracted position. The housing defines a recess in the rear side. When the clamp is in the retracted position the arm is received within the recess.

The present disclosure provides, in another aspect, a charging module configured to be removably coupled to a mobile work cart. The charging module includes a case defining a chamber and an opening communicating with the chamber. The charging module also includes a door coupled to the case and movable between a closed position enclosing the chamber and an open position permitting access to the chamber via the opening. The charging module further includes a shelf pivotably coupled to the case and supported within the chamber, the shelf being pivotable relative to the case between a retracted position away from the opening and a deployed position extending toward the opening. The charging module also includes a charging bay supported on the shelf, the charging bay being configured to removably receive a battery pack to electrically connect the battery pack to the charging module.

The present disclosure provides, in another aspect, a charging module configured to be removably coupled to a mounting plate having a plurality of cleat receptacles. The charging module includes a housing having a first end, a second end opposite the first end, a front side, a rear side opposite the front side, a bottom side, and a top side opposite the bottom side. The housing defines a handle at the first end. The housing includes a plurality of cleats formed on the bottom side and configured to insert into the plurality of cleat receptacles of the mounting plate. The charging module also includes a plurality of charging bays located at the top side of the housing, each charging bay being configured to removably receive a battery pack to electrically connect the battery pack to the charging module. The charging module further includes a male AC port supported on the housing.

### BRIEF DESCRIPTION OF THE DRAWINGS

FIGS. 1-4 are perspective views of a charging module according to an embodiment of the disclosure.

FIG. 5A is a perspective view of the charging module of FIG. 1 supported on a work cart.

FIGS. 5B and 5C are perspective views of battery packs operable with a charging module.

FIGS. 6 and 7 are perspective views of a charging module according to another embodiment of the disclosure.

FIGS. 8-10 are elevation views of the charging module of FIG. 6.

FIG. 11 is a perspective view of an alternating current/direct current (AC/DC) power adapter operable to supply direct current (DC) power to a charging module.

FIGS. 12 and 13 are perspective views of a charging module according to another embodiment of the disclosure.

FIGS. 14-16 are elevation views of the charging module of FIG. 12.

FIGS. 17 and 18 are perspective views of a charging module according to another embodiment of the disclosure.

FIG. 19 is an elevation view of the charging module of FIG. 17.

FIG. 20 is a perspective view of a charging module according to another embodiment of the disclosure.

FIG. 21 is an elevation view of the charging module of FIG. 20.

FIGS. 22 and 23 are perspective views of a charging module according to another embodiment of the disclosure.

FIGS. 24 and 25 are perspective views of a charging module according to another embodiment of the disclosure.

FIG. 26 is a perspective view of a mounting plate configured to support the charging module of FIG. 24.

FIGS. 27 and 28 are perspective views illustrating several positions at which the charging module of FIG. 24 can be mounted on the work cart of FIG. 5 using the mounting plate of FIG. 26.

FIGS. 29 and 30 are perspective views illustrating the charging module of FIG. 24 and a lock plate engageable with the charging module.

FIGS. 31 and 32 are perspective views of a charging module according to another embodiment of the disclosure.

FIGS. 33 and 34 are perspective views of a charging module according to another embodiment of the disclosure.

FIG. 35 is an elevation view of the charging module of FIG. 33.

FIG. 36 is a perspective view of a charging module according to another embodiment of the disclosure.

FIG. 37 is an elevation view of the charging module of FIG. 36.

FIGS. 38 and 39 are perspective views of the charging module of FIG. 36 and security covers engageable with the charging module.

FIGS. 40A and 40B are perspective views of a charging module according to another embodiment of the disclosure that is supported on the work cart of FIG. 5.

FIGS. 41A-41C are perspective views of all or portions of a charging module according to another embodiment of the disclosure that is supported on the work cart of FIG. 5.

FIGS. 42A and 42B are perspective views of a charging module according to another embodiment of the disclosure that is supported on the work cart of FIG. 5.

FIGS. 43A-43D are perspective views of all or portions of a charging module according to another embodiment of the disclosure that is supported on the work cart of FIG. 5.

FIGS. 44A and 44B are perspective views of a charging module according to another embodiment of the disclosure that is supported on the work cart of FIG. 5.

FIGS. 45A-45C are perspective views of all or portions of a charging module according to another embodiment of the disclosure that is supported on the work cart of FIG. 5.

FIGS. 46A and 46B are perspective views of a charging module according to another embodiment of the disclosure that is supported on the work cart of FIG. 5.

FIGS. 47A-47C are perspective views of a charging module according to another embodiment of the disclosure that is supported on the work cart of FIG. 5.

FIGS. 48A and 48B are perspective views of a charging module according to another embodiment of the disclosure that is supported on the work cart of FIG. 5.

FIGS. 49A-49C are perspective views of a charging module according to another embodiment of the disclosure that is supported on the work cart of FIG. 5.

FIGS. 50A-50C are perspective views of a charging module according to another embodiment of the disclosure that is supported on the work cart of FIG. 5.

FIGS. 51A and 51B are perspective views of a charging module according to another embodiment of the disclosure that is supported on the work cart of FIG. 5.

FIG. 51C is a perspective view illustrating the charging module of FIG. 51A and a mounting plate configured to support the charging module on the work cart of FIG. 5.

FIG. 51D is a perspective view of the mounting plate of FIG. 51C mounted to the work cart of FIG. 5.

FIGS. 52A and 52B are perspective views of a charging module according to another embodiment of the disclosure.

FIG. 52C is a perspective view of the charging module of FIG. 52A supported on the work cart of FIG. 5.

FIGS. 53A-53C are perspective views of a charging module according to another embodiment of the disclosure that is supported on the work cart of FIG. 5.

FIG. 54A is a perspective view of a charging module according to another embodiment of the disclosure that is supported on the work cart of FIG. 5.

FIG. 54B is a perspective view of the charging module of FIG. 54A.

FIGS. 55A-55C are perspective views of a charging module according to another embodiment of the disclosure that is supported on the work cart of FIG. 5.

FIGS. 56A-56D are perspective views of all or portions of a charging module according to another embodiment of the disclosure that is supported on the work cart of FIG. 5.

FIG. 57A is a perspective view of a charging module according to another embodiment of the disclosure.

FIGS. 57B-57D are perspective views of the charging module of FIG. 57A supported on the work cart of FIG. 5.

FIG. 58 is a perspective view of a charging module according to another embodiment of the disclosure that is supported on the work cart of FIG. 5.

FIG. 59 is a perspective view of a charging module according to another embodiment of the disclosure that is supported on the work cart of FIG. 5.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

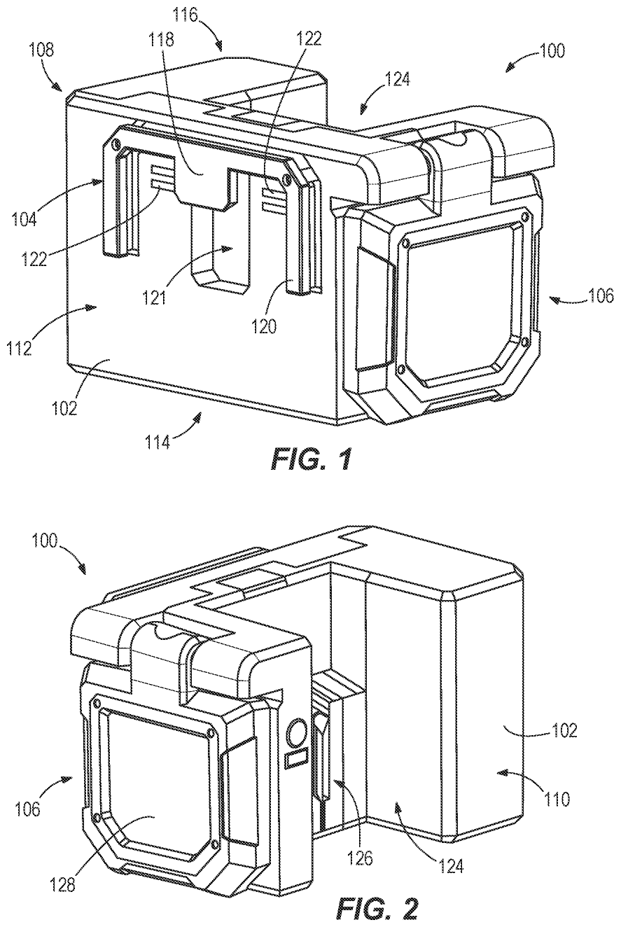

FIGS. 1-5 illustrate a charging module 100 operable to charge a battery pack, such as a 12-Volt “post-type” battery pack 10 (FIG. 5B) and/or an 18-Volt “rail-type” battery pack 20 (FIG. 5C). The charging module 100 is adapted to be coupled to and/or supported on a mobile work cart such as the mobile work cart 50 (FIG. 5A). The work cart 50 includes a lower shelf 52, an upper shelf 54, and four legs 56 extending between the lower and upper shelves 52, 54 at the four respective corners of the shelves 52, 54. The work cart 50 also includes a handle 58 located at a longitudinal end of the upper shelf 54, and wheels (not shown) coupled to a bottom of the lower shelf 52. The work cart 50 further includes a vertically-extending lip 60 formed around the perimeter of each of the shelves 52, 54.

The charging module 100 can be removably coupled to a side of the mobile work cart 50. The charging module 100 is relatively compact and creates a minimal footprint. Therefore, the charging module 100 does not require shelf space on the work cart 50. With reference to FIGS. 1 and 2, the charging module 100 includes a housing 102 and a clamp 104 coupled to the housing 102. The housing 102 includes a first end 106, a second end 108, a front side 110, a rear side 112, a bottom side 114, and a top side 116. In the illustrated embodiment, the clamp 104 is configured as a spring clamp 104 coupled to the rear side 112 of the housing 102. The clamp 104 is operable to secure the charging module 100 to the side of the work cart 50.

The clamp 104 has a generally flat shape and includes a handle portion 118 and two arms 120 extending downward from opposite ends of the handle portion 118 in a direction toward the bottom side 114. The clamp 104 is movable relative to the housing 102 in a direction toward or away from the rear side 112. The clamp 104 can move between a deployed position and a retracted position. In the deployed position, the handle portion 118 and the arms 120 are spaced apart from the housing 102. In the retracted position, the handle portion 118 and the arms 120 are flush with the surrounding surface of the housing 102. In this regard, the housing 102 includes a recessed region 121 that receives the handle portion 118 and the arms 120 so that the surface of the clamp 104 is flush with the surface of the housing 102 in the retracted position. The clamp 104 is sprung or biased toward the retracted position. When the clamp 104 is pulled out to the deployed position, the lip 60 of the work cart 50 can be inserted into the space between the arms 120 and the housing 102 to secure the charging module 100 on the work cart 50.

The charging module 100 further includes permanent magnets 122 embedded into the surface of the housing 102 at the rear side 112. The magnets 122 are located adjacent the clamp 104. When the charging module 100 is secured to the lip 60 of the work cart 50 via the clamp 104, the magnets 122 magnetically adhere to the lip 60 (in the case of metal work carts) to complement the clamp 104 and further secure the charging module 100 to the work cart 50. Alternatively, the magnets 122 can secure the charging module 100 to a metal worksurface, such as the work surface 123 of FIG. 4, without the use of the clamp 104.

With continued reference to FIGS. 1 and 2, the housing 102 defines a central recess 124 in the front side 110. The housing 102 further includes a charging bay 126 located within the central recess 124. The charging bay 126 can removably receive a battery pack such as the battery packs 10, 20 (i.e., 12-Volt and/or 18-Volt battery packs). The charging module 100 can charge the battery pack 10, 20 when the battery pack is coupled to the charging bay 126. In the illustrated embodiment, the housing 102 includes a single charging bay 126. Therefore, the charging module 100 is generally compact. The charging bay 126 includes a first battery receptacle that can removably receive the first battery pack 10, and a second battery receptacle that can removably receive the second battery pack 20.

The charging module 100 additionally includes a task light 128 pivotably coupled to the housing 102 at the first end 106. The task light 128 may be powered from a direct current (DC) power source, such as the battery pack 10, 20 when the battery pack is coupled to the charging bay 126. The task light 128 may additionally or alternatively be powered by an alternating current (AC) power source.

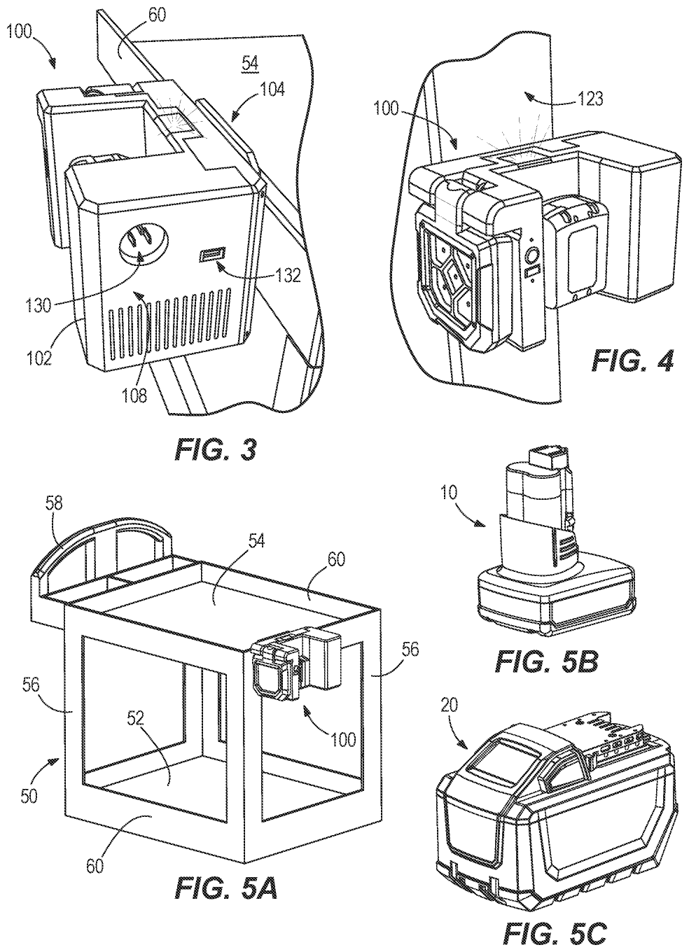

With reference to FIG. 3, the charging module 100 includes a male AC plug 130 for connecting the charging module 100 to the AC power source via a power cord (not shown). In addition, the charging module 100 includes a Universal Synchronous Bus (USB) port 132 for receiving a USB cable (not shown). The USB port 132 is operable to charge an accessory electronic device (e.g., a smart phone, a tablet computer, and the like) via the USB cable. Other suitable charging ports and/or plugs may also or alternative be included on the charging module.

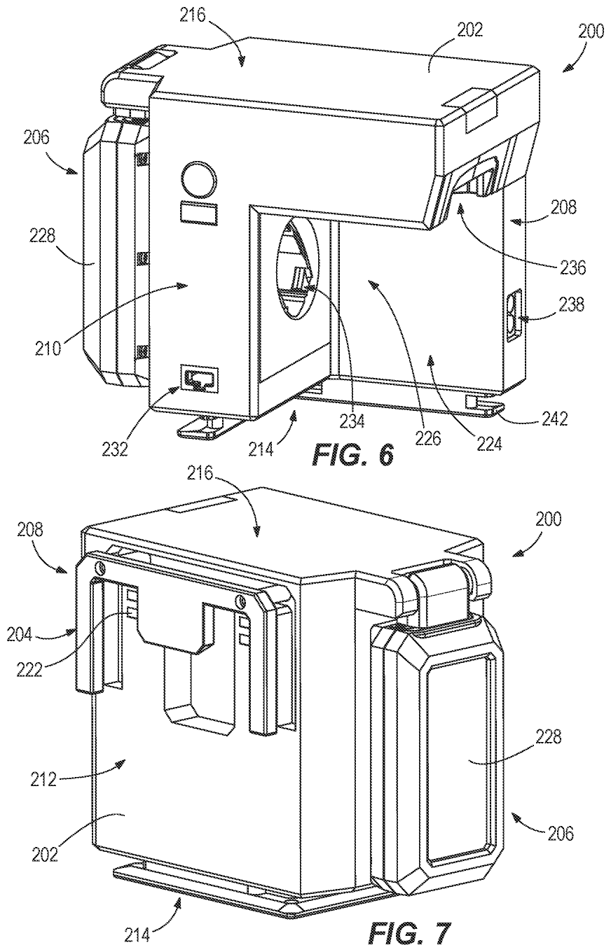

FIGS. 6-11 illustrate a charging module 200 according to another embodiment of the disclosure. The charging module 200 is similar to the charging module 100 described herein and includes many of the same features and elements. Features and elements of the charging module 200 that correspond to like features and elements of the charging module 100 are assigned the same reference numerals “plus 100.” The following description will focus on the differences between the charging module 200 and the charging module 100. It should be understood that any features and elements of the charging module 200 not specifically addressed herein are the same as the features and elements of the charging module 100 described above.

With reference to FIGS. 6 and 7, the charging module 200 includes a housing 202 and a clamp 204 coupled to the housing 202. The housing 202 includes a first end 206, a second end 208, a front side 210, a rear side 212, a bottom side 214, and a top side 216. The clamp 204 is configured as a spring clamp 204 coupled to the rear side 212 of the housing 202. The clamp 204 is substantially similar to the clamp 104 described above and is operable to secure the charging module 200 to the side of the work cart 50 in the same manner as described above for the clamp 104. The charging module 200 further includes permanent magnets 222 embedded into the surface of the housing 202 at the rear side 212.

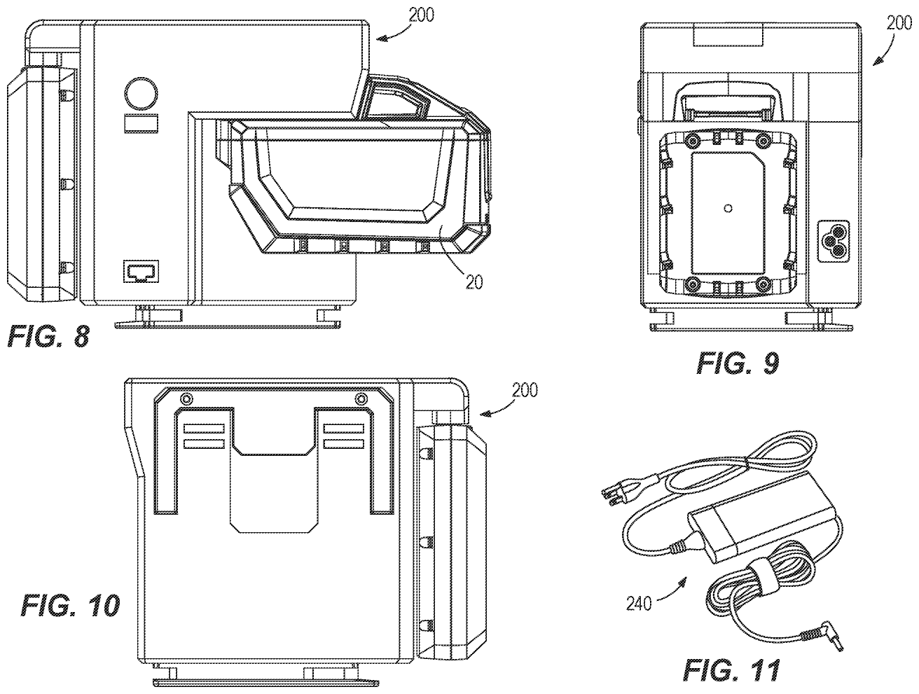

With continued reference to FIGS. 6 and 7, the housing 202 defines a corner cavity 224 in the front side 210, the bottom side 214, and the second end 208. The housing 202 further includes a charging bay 226 located within the corner cavity 224. The charging bay 226 can removably receive a battery pack such as the battery packs 10, 20 (i.e., 12-Volt and/or 18-Volt battery packs). The charging module 200 can charge the battery pack 10, 20 when the battery pack is coupled to the charging bay 226. In the illustrated embodiment, the housing 202 includes a single charging bay 226. Therefore, the charging module 200 is generally compact. The charging bay 226 includes a first battery receptacle 234 and a second battery receptacle 236. The first battery receptacle 234 is located toward the first end 206 of the housing 202, and the second battery receptacle 236 is located toward the top side 216. With reference to FIGS. 8 and 9, the first battery receptacle 234 can removably receive the first battery pack 10 and the second battery receptacle 236 can removably receive the second battery pack 20.

With reference to FIGS. 6-10, the charging module 200 additionally includes a task light 228 pivotably coupled to the housing 202 at the first end 206. The task light 228 may be powered from a DC power source, such as the battery pack 10, 20 when the battery pack is coupled to the charging bay 226. The task light 228 may additionally or alternatively be powered by an AC power source.

With reference to FIG. 9, the charging module 200 includes a female plug 238 for connecting the charging module 200 to a power source via a power cord (not shown). In some embodiments, the charging module is configured to receive AC power via the plug 238. In other embodiments, the plug 238 can connect to a DC power source, such as an external AC/DC power adapter like the power adapter 240 shown in FIG. 11. In addition, the charging module 200 includes a Universal Synchronous Bus (USB) port 232 for receiving a USB cable (not shown). The USB port is operable to charge an accessory electronic device (e.g., a smart phone, a tablet computer, and the like) via the USB cable. Other suitable charging ports and/or plugs may also or alternative be included on the charging module. The charging module 200 further includes a protrusion 242 extending from the bottom side 214 of the housing 202. The protrusion 242 defines a cord wrap for wrapping a power cord.

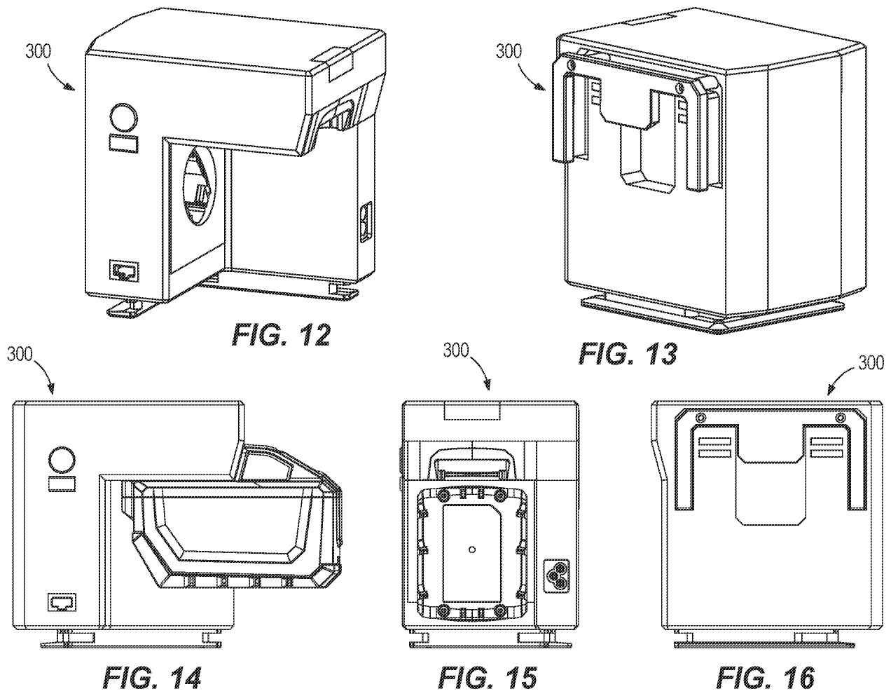

FIGS. 12-16 illustrate a charging module 300 according to another embodiment of the disclosure. The charging module 300 is substantially similar to the charging module 200 described herein and includes all of the same features and elements, except that the charging module 300 does not include a task light. As such, the charging module 300 has a smaller form factor than the charging module 200 and takes up less space on the work cart 50.

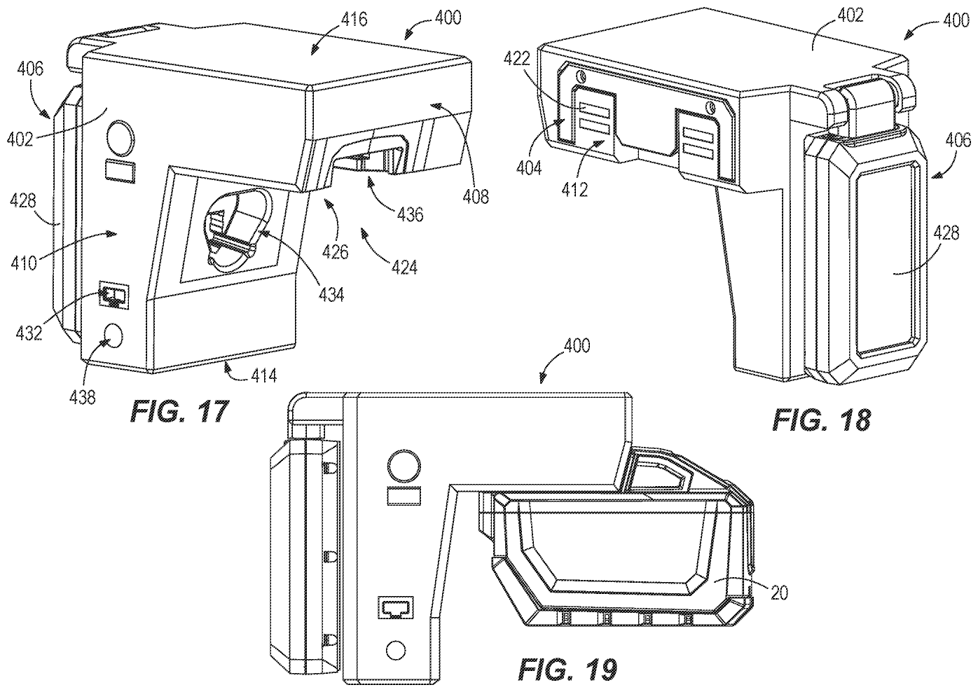

FIGS. 17-19 illustrate a charging module 400 according to another embodiment of the disclosure. The charging module 400 is similar to the charging module 200 described herein and includes many of the same features and elements. Features and elements of the charging module 400 that correspond to like features and elements of the charging module 200 are assigned the same reference numerals “plus 200.” The following description will focus on the differences between the charging module 400 and the charging module 200. It should be understood that any features and elements of the charging module 400 not specifically addressed herein are the same as the features and elements of the charging module 200 described above.

The charging module 400 includes a housing 402 and a clamp 404 coupled to the housing 402. The housing 402 includes a first end 406, a second end 408, a front side 410, a rear side 412, a bottom side 414, and a top side 416. The clamp 404 is configured as a spring clamp 404 coupled to the rear side 412 of the housing 402. The clamp 404 is substantially similar to the clamp 104 described above and is operable to secure the charging module 400 to the side of the work cart 50 in the same manner as described above for the clamp 404. The charging module 400 further includes permanent magnets 422 embedded into the surface of the housing 402 at the rear side 412.

The housing 402 defines a corner cavity 424 in the bottom side 414 and the second end 408. As such, the housing 402 has a general “L” shape. The housing 402 further includes a charging bay 426 located within the corner cavity 424. The charging bay 426 can removably receive a battery pack such as the battery packs 10, 20 (i.e., 12-Volt and/or 18-Volt battery packs). The charging module 400 can charge the battery pack 10, 20 when the battery pack is coupled to the charging bay 426. In the illustrated embodiment, the housing 402 includes a single charging bay 426. Therefore, the charging module 400 is generally compact. The charging bay 426 includes a first battery receptacle 434 and a second battery receptacle 436. The first battery receptacle 434 is located toward the first end 406 of the housing 402, and the second battery receptacle 436 is located toward the top side 416. The first battery receptacle 434 can removably receive the first battery pack 10 and the second battery receptacle 436 can removably receive the second battery pack 20.

The charging module 400 additionally includes a task light 428 pivotably coupled to the housing 402 at the first end 406. The task light 428 may be powered from a DC power source, such as the battery pack 10, 20 when the battery pack is coupled to the charging bay 426. The task light 428 may additionally or alternatively be powered by an AC power source.

The charging module 400 includes a female plug 438 for connecting the charging module 400 to a power source via a power cord (not shown). In some embodiments, the charging module is configured to receive AC power via the plug 438. In other embodiments, the plug 438 can connect to a DC power source, such as an external AC/DC power adapter like the power adapter 440 shown in FIG. 11. In addition, the charging module 400 includes a Universal Synchronous Bus (USB) port 432 for receiving a USB cable (not shown). The USB port is operable to charge an accessory electronic device (e.g., a smart phone, a tablet computer, and the like) via the USB cable. Other suitable charging ports and/or plugs may also or alternative be included on the charging module.

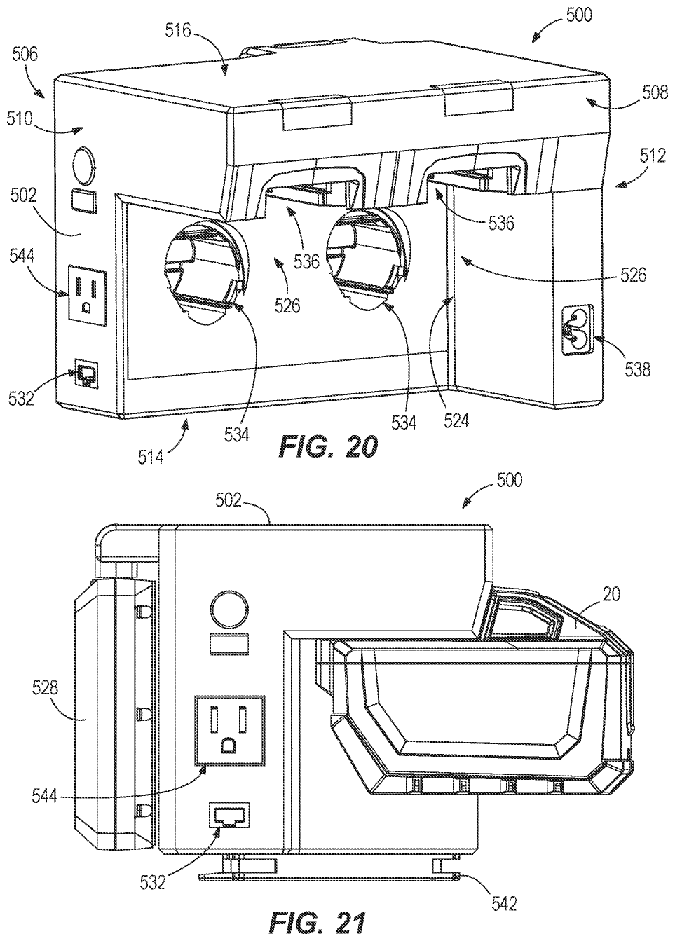

FIGS. 20-21 illustrate a charging module 500 according to another embodiment of the disclosure. The charging module 500 is similar to the charging module 200 described herein and includes many of the same features and elements. Features and elements of the charging module 500 that correspond to like features and elements of the charging module 200 are assigned the same reference numerals “plus 300.” The following description will focus on the differences between the charging module 500 and the charging module 200. It should be understood that any features and elements of the charging module 500 not specifically addressed herein are the same as the features and elements of the charging module 200 described above.

The charging module 500 includes a housing 502 and a clamp (not shown) coupled to the housing 502. The clamp is substantially similar to the clamp 104 of the charging module 100 described above and is operable to secure the charging module 500 to the side of the work cart 50 in the same manner as described above for the clamp 104. The housing 502 includes a first end 506, a second end 508, a front side 510, a rear side 512, a bottom side 514, and a top side 516. The clamp is configured as a spring clamp coupled to the rear side 512 of the housing 502. The charging module 500 further includes permanent magnets (not shown) embedded into the surface of the housing 502 at the rear side 512.

The housing 502 is elongated longitudinally between the front side 510 and the rear side 512, and defines a corner cavity 524 in the front side 510, the bottom side 514, and the second end 508. The housing 502 further includes two charging bays 526 located within the corner cavity 524 and positioned side by side. The charging bays 526 can each removably receive a battery pack such as the battery packs 10, 20 (i.e., 12-Volt and/or 18-Volt battery packs). The charging module 500 can charge the battery packs 10, 20 when the battery packs are coupled to the charging bays 526. Each charging bay 526 includes a first battery receptacle 534 and a second battery receptacle 536. The first battery receptacle 534 is located toward the first end 506 of the housing 502, and the second battery receptacle 536 is located toward the top side 516. The first battery receptacle 534 can removably receive the first battery pack 10 and the second battery receptacle 536 can removably receive the second battery pack 20.

The charging module 500 additionally includes a task light 528 pivotably coupled to the housing 502 at the first end 506. The task light 528 may be powered from a DC power source, such as the battery pack 10, 20 when the battery pack is coupled to the charging bay 526. The task light 528 may additionally or alternatively be powered by an AC power source.

The charging module 500 includes a female plug 538 for connecting the charging module 500 to a power source via a power cord (not shown). In some embodiments, the charging module is configured to receive AC power via the plug 538. In other embodiments, the plug 538 can connect to a DC power source, such as an external AC/DC power adapter like the power adapter 540 shown in FIG. 11. In addition, the charging module 500 includes a Universal Synchronous Bus (USB) port 532 for receiving a USB cable (not shown). The USB port is located at the front side 510 and is operable to charge an accessory electronic device (e.g., a smart phone, a tablet computer, and the like) via the USB cable. In the illustrated embodiment, the charging module 500 further includes an AC port 544 located at the front side 510 adjacent the USB port 532. The AC port 544 is connectable to tools and/or other equipment that have an AC power plug connector. In alternative embodiments, the charging module 500 may include additional AC ports. In the illustrated embodiment, the charging bay 526 located closest to the front side 510 is a dedicated charging bay for powering the AC port 544. The charging module 500 further includes a protrusion 542 extending from the bottom side 514 of the housing 502. The protrusion 542 defines a cord wrap for wrapping a power cord.

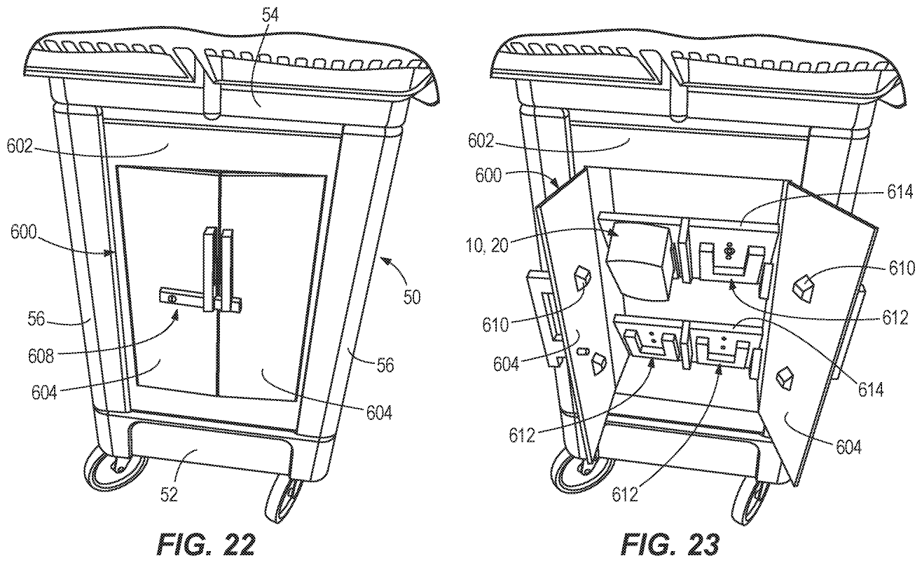

FIGS. 22-23 illustrate a charging module 600 according to another embodiment of the disclosure. The charging module 600 is adapted to be coupled to and/or supported on a mobile work cart such as the mobile work cart 50 (FIG. 5A). The charging module 600 is removably coupled underneath the mobile work cart 50 (e.g., on the lower shelf 52 of the mobile work cart 50). More specifically, the charging module 600 is shaped and sized to snugly fit underneath the upper shelf 54 of the mobile work cart 50 and is secured to two legs 56 of the work cart 50. The charging module 600 is configured as a rectangular cabinet including a rectangular case 602 and two doors 604 movable between a closed position and an open position. The case 602 additionally forms a storage chamber 606 for storing various power sources (e.g., battery packs such as the battery packs 10, 20) and defines an opening communicating with the storage chamber 606. The doors 604 close the opening in the closed position. The doors 604 include a lock mechanism 608 for securing the doors 604 in the closed position. Inner surfaces of the doors 604 include protrusions or tabs 610 extending into the storage chamber 606.

The storage chamber 606 includes various charging bays 612 formed therein for receiving at least one battery pack such as the battery packs 10, 20. The charging module 600 can charge the battery packs 10, 20 when the battery packs are coupled to the charging bay 612. The charging bays 612 are provided on pivotable shelves 614 that are pivotable between a retracted vertical orientation and a deployed slanted position. Specifically, the charging module 600 includes two pivotable shelves 614 extending laterally between the sides of the case 602 and arranged above and below one another, respectively. Each shelf 614 includes two charging bays 612. When the doors 604 are closed, the tabs 610 engage each of the shelves 614 and pivot the shelves 614 to the retracted position oriented horizontally and parallel to the closed doors 604.

When a user opens the doors 604, the tabs 610 disengage from the shelves 614, thereby causing the charging bays to pivot downward toward the opening to the deployed position oriented at a slant or slope relative to the retracted position. When in the deployed position, the shelves 614 are generally parallel to one another and the battery packs 10, 20 positioned on the charging bays 612 are prevented from slipping off of the charging bays 612. The pivoting shelves 614 allow for compact storage (i.e., when the doors 604 are closed and the shelves 614 are in the retracted position), and allow for easy battery pack access and removal (i.e., when the doors 604 are open and the shelves 614 are in the deployed position). In the illustrated embodiments, the storage charging module 600 includes four charging bays 612. However, in other embodiments, the charging module 600 may include fewer or additional charging bays.

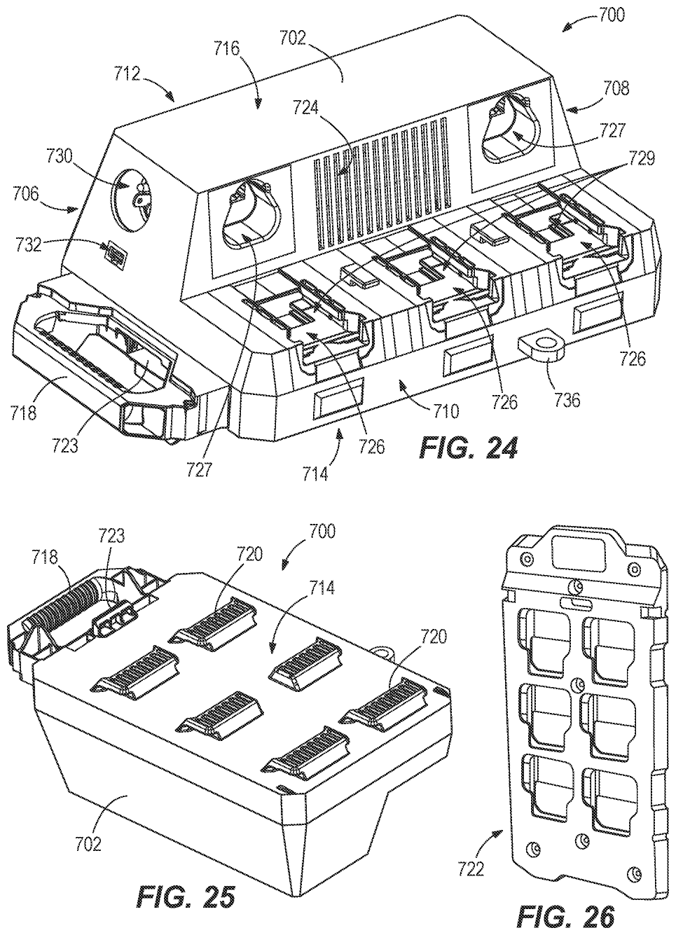

FIGS. 24, 25, 29, and 30 illustrate a charging module 700 according to another embodiment of the disclosure. The charging module 700 is operable to charge a battery pack, such as a 12-Volt “post-type” battery pack 10 (FIG. 5B) and/or an 18-Volt “rail-type” battery pack 20 (FIG. 5C). The charging module 100 is adapted to be coupled to and/or supported on a mobile work cart such as the mobile work cart 50 (FIG. 5A).

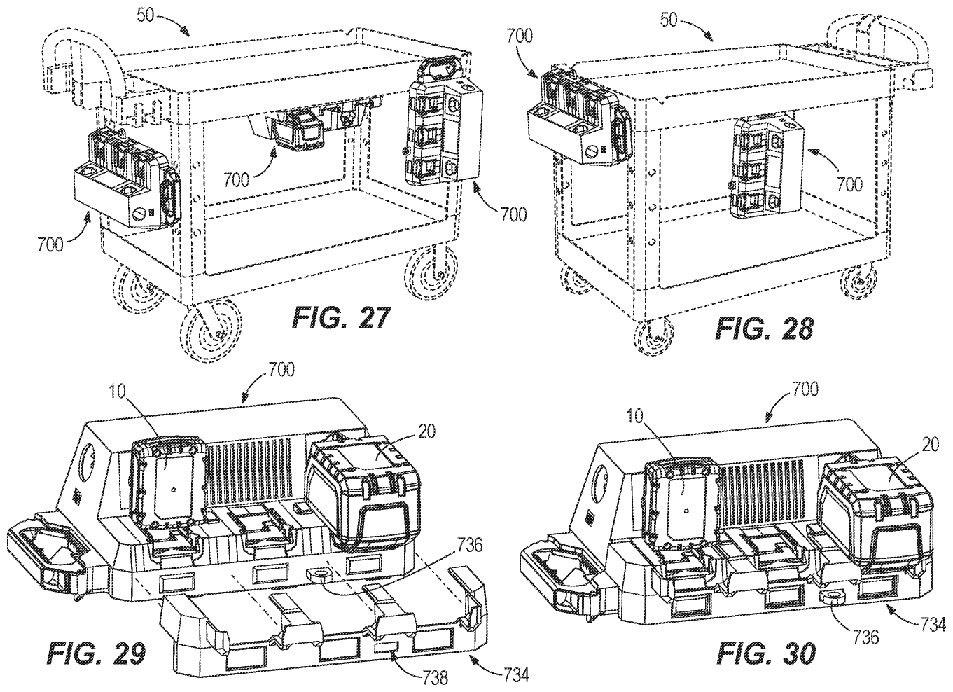

With reference to FIGS. 24 and 25, the charging module 700 includes a housing 702 having a first end 706, a second end 708, a front side 710, a rear side 712, a bottom side 714, and a top side 716. The housing 702 includes a handle 718 formed at the first end 706. The housing 702 also includes a set of cleats 720 formed at the bottom side 714 and configured to mount onto an accessory mount plate, such as the mount plate 722 shown in FIG. 26. The mount plate 722 is configured to couple the charging module 700 to the cart 50. Specifically, the mount plate 722 can be attached to the work cart 50 at a variety of locations, as illustrated in FIGS. 27 and 28, to secure the charging module 700 to the work cart 50. The mount plate 722 defines a plurality of recesses or cleat receptacles. The cleat receptacles receive the cleats 720 to releasably secure the charging module 700 to the mount plate 722. In particular, the cleats 720 and the cleat receptacles each define a pair of ridges that engage one another when the cleats 720 are inserted into the cleat receptacles. The charging module 700 further includes a latch 723 located adjacent the handle 718 and operable to lock the charging module 700 to the mount plate 722 or release the charging module 700 therefrom.

The housing 702 further defines a corner recess 724 formed in the front side 710 and the top side 716. The charging module 700 includes multiple charging bays 726 located within the corner recess 724. The charging bays 726 can removably receive a battery pack such as the battery packs 10, 20 (i.e., 12-Volt and/or 18-Volt battery packs). The charging module 700 can charge the battery packs 10, 20 when the battery packs are coupled to the charging bays 726. In the illustrated embodiment, the housing 702 includes three charging bays 726 and can charge three of the battery packs 10, 20 simultaneously. Two of the charging bays 726 located nearest to the first end 706 and the second end 708, respectively, each include a first battery receptacle 727 and a second battery receptacle 729. The first battery receptacle 727 can removably receive the first battery pack 10, and the second battery receptacle 729 can removably receive the second battery pack 20. The remaining charging bay 726 located in the center of the housing 702 includes only a second battery receptacle 729 for receiving the second battery pack 20.

With continued reference to FIGS. 24 and 25, the charging module 700 includes a male AC plug 730 located at the first end 706 for connecting the charging module 700 to an AC power source via a power cord (not shown). In addition, the charging module 700 includes a Universal Synchronous Bus (USB) port 732 located at the first end 706 for receiving a USB cable (not shown). The USB port 732 is operable to charge an accessory electronic device (e.g., a smart phone, a tablet computer, and the like) via the USB cable. Other suitable charging ports and/or plugs may also or alternative be included on the charging module.

With reference to FIGS. 29 and 30, the charging module 700 is capable of receiving an accessory lock plate 734 to selectively secure the battery packs 20 to the charging bays 726. The lock plate 734 can slide onto the housing 702 at the front side 710. When the lock plate 734 is secured to the charging module 700, the lock plate 734 surrounds the release buttons of the battery packs 20 so that the battery packs 20 cannot be removed from the charging module 700 (e.g., to prevent theft of the battery packs). The housing 702 includes a lock tab 736, and the lock plate 734 includes a lock aperture 738 that receives the lock tab 736. An accessory lock, such as a padlock, can be attached to the lock tab 736 to lock the lock plate 734 to the charging module 700.

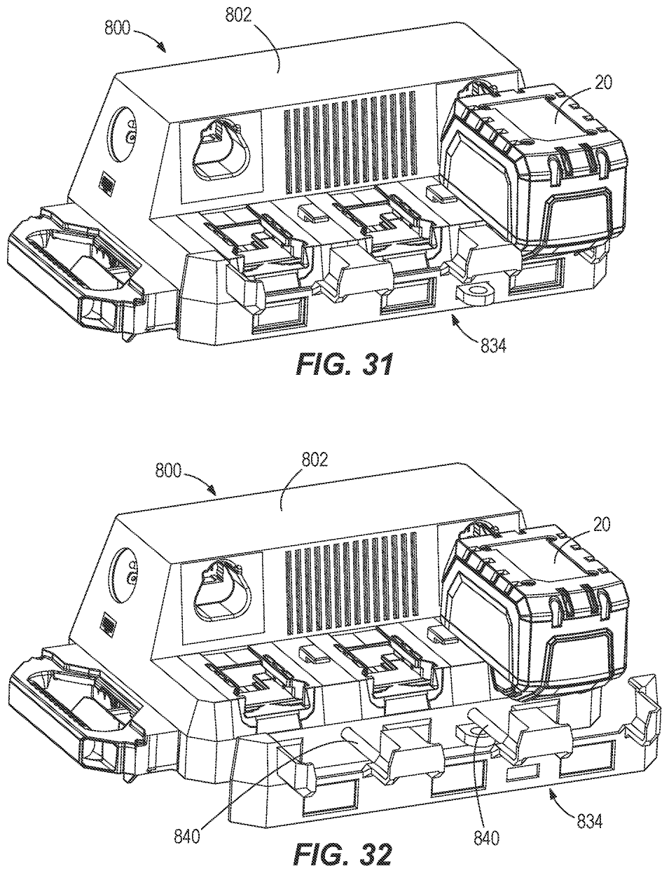

FIGS. 31 and 32 illustrate a charging module 800 according to another embodiment of the disclosure. The charging module 800 is substantially similar to the charging module 700, except that the charging module 800 includes a modified or integrated lock plate 834 that is non-removably coupled to the housing 802 by two slide rails 840. As such, the lock plate 834 can slide between a lock position (FIG. 31) and a release position (FIG. 32). The lock plate 834 is permanently carried by the housing 802 of the charging module 800.

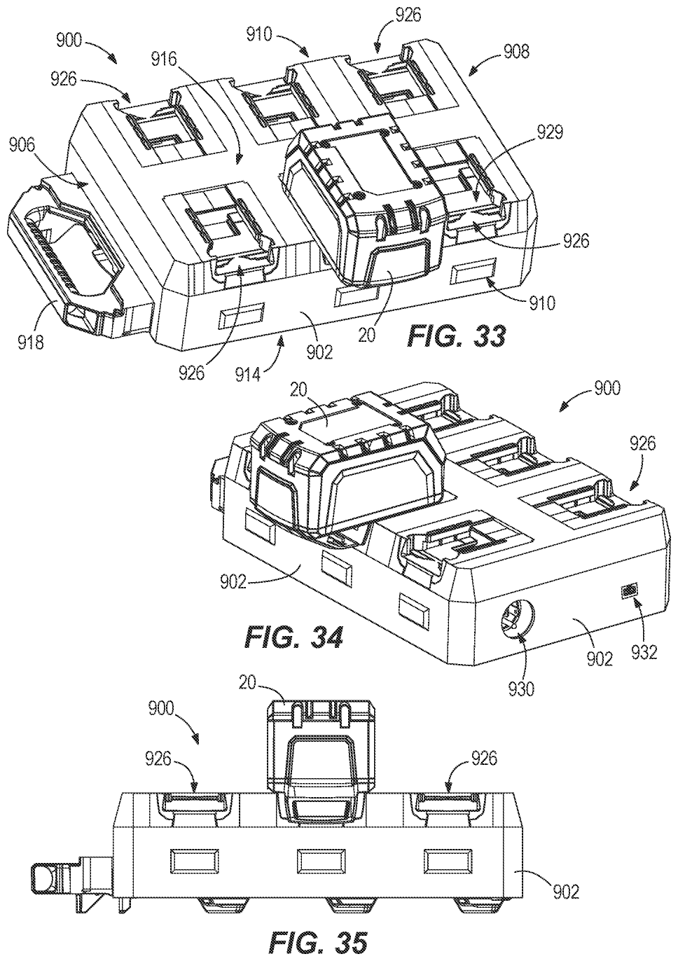

FIGS. 33-35 illustrate a charging module 900 according to another embodiment of the disclosure. The charging module 900 is similar to the charging module 700 described herein and includes many of the same features and elements. Features and elements of the charging module 900 that correspond to like features and elements of the charging module 700 are assigned the same reference numerals “plus 200.” The following description will focus on the differences between the charging module 900 and the charging module 700. It should be understood that any features and elements of the charging module 900 not specifically addressed herein are the same as the features and elements of the charging module 700 described above.

The charging module 900 includes a housing 902 that includes multiple charging bays 926. Unlike the charging module 700, the housing 902 of the charging module 900 does not include a corner recess. Instead, the charging bays 926 of the charging module 900 are formed in a top side 916 of the housing 902. In the illustrated embodiment, the charging module 900 includes six charging bays 926 formed in the top side 916, with three of the charging bays 926 located at the front side 910 and three of the charging bays 926 located at the rear side 912. Each of the charging bays 926 includes only a second battery receptacle 929 for receiving the second battery pack 20. Like the charging module 700, the charging module 900 also includes a male AC plug 930 and a Universal Synchronous Bus (USB) port 932. Unlike the charging module 700, the AC plug 930 and the USB port 932 of the charging module 900 are each located at a second end 908 of the housing 902, rather than at a first end 906 near a handle 918.

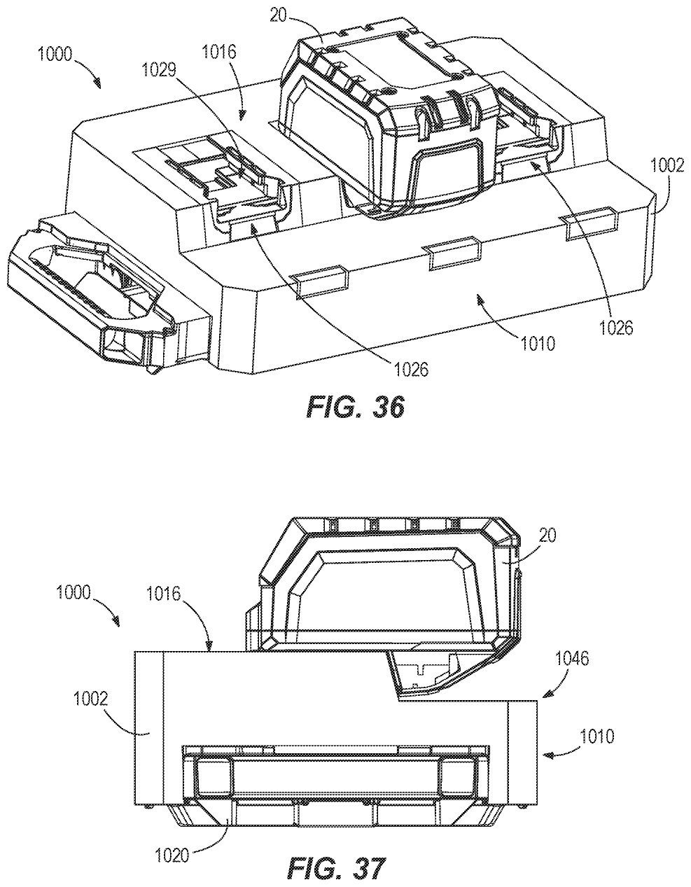

FIGS. 36-39 illustrate a charging module 1000 according to another embodiment of the disclosure. The charging module 1000 is similar to the charging module 900 described herein and includes many of the same features and elements. Features and elements of the charging module 1000 that correspond to like features and elements of the charging module 900 are assigned the same reference numerals “plus 100.” The following description will focus on the differences between the charging module 1000 and the charging module 900. It should be understood that any features and elements of the charging module 1000 not specifically addressed herein are the same as the features and elements of the charging module 900 described above.

The charging module 1000 includes a housing 1002 that includes multiple charging bays 1026. Unlike the charging module 900, the charging module 1000 includes three charging bays 1026 rather than six. The charging bays 1026 of the charging module 1000 are formed in a top side 1016 of the housing 1002. Each of the charging bays 1026 includes only a second battery receptacle 1029 for receiving the second battery pack 20.

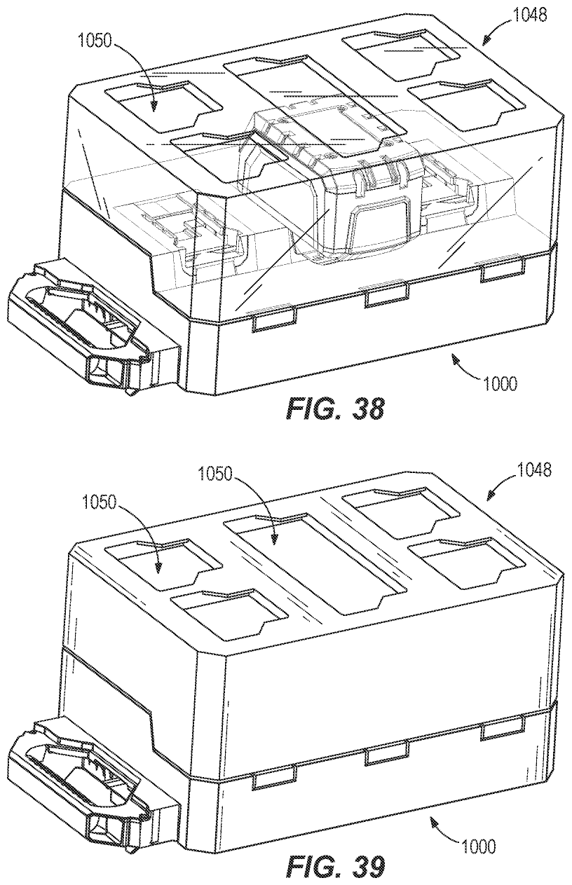

The housing 1002 defines a footprint when viewed facing the top side 1016. The footprint is sufficiently large so that the battery packs 20 reside within the footprint when the battery packs 20 are coupled to the charging bays 1026. In other words, as shown in FIG. 37, an edge 1046 of the housing 1002 is formed where the top side 1016 meets the front side 1010, and the edge 1046 extends outward beyond an end of the battery pack 20 when the battery pack is coupled to any of the charging bays 1026. As shown in FIGS. 38 and 39, the housing 1002 can removably couple to an accessory cover 1048. The cover 1048 can be, e.g., clear (FIG. 38), or opaque (FIG. 39). The cover 1048 can secure the battery packs 20 within. When the cover 1048 is coupled to the housing 1002, the cover 1048 covers the charging bays 1026. Moreover, the cover 1048 cooperates with the housing 1002 to define a rectangular prismatic shape that is stackable. In this regard, the cover 1048 includes recesses 1050 formed in a top side thereof at locations corresponding to the cleats 1020 of the housing 1002. When two charging modules 1000 equipped with covers 1048 are stacked one atop the other, the cleats 1020 of one charging module 1000 are received into the recesses 1050 in the cover 1048 of the other charging module 1000.

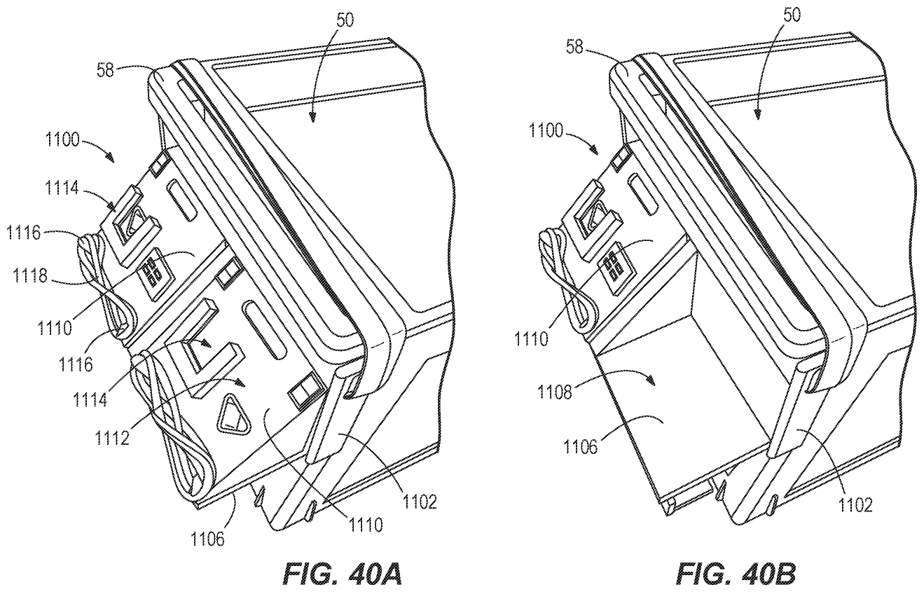

FIGS. 40A and 40B illustrate charging module 1100 according to another embodiment of the disclosure. The charging module 1100 is adapted to be coupled to and/or supported on a mobile work cart such as the mobile work cart 50 (FIG. 5A). The charging module 1100 includes a frame 1102 that removably couples to a portion the mobile work cart 50, such as the handle 58. As shown in FIGS. 40A and 40B, the frame 1102 is removably coupled to the handle 58 via a cable mounting assembly embodied as a strap 1104. In other embodiments (not shown), the cable mounting assembly may include other structures in place of a strap (e.g., a cable, a hook, and the like). The strap 1104 allows the frame 1102 to be removably coupled to mobile work carts of various shapes and sizes. The frame 1102 is positioned under the handle 58 of the work cart 50 (e.g., within a negative space underneath the handle 58). The frame 1102 includes at least one shelf 1106 that forms one or more compartments 1108 shaped and sized to receive a charger 1110 and/or store accessories (a tool organizer, a cart organizer, etc.). In the illustrated embodiment, the frame 1102 includes two compartments 1108. However, the frame 1102 may include fewer or additional compartments.

With continued reference to FIGS. 40A and 40B, the charger 1110 is sized and shaped to fit snugly within the compartment 1108. I the illustrated embodiment, the charger 1110 is shaped approximately as a triangular prism having a top side 1112 that is sloped relative to the shelf 1106. The top side 1112 includes a charging bay 1114 formed thereon for receiving at least one battery pack such as the battery packs 10, 20. The charger 1110 can charge the battery packs 10, 20 when the battery packs are coupled to the charging bay 1114. The top side 1112 further includes a pair of opposed protrusions 1116 that together form a cord wrap for wrapping a cord 1118 of the of the charger 1110 therearound. The charger 1110 may additionally include at least one Universal Synchronous Bus (USB) port (not shown) for receiving a USB cable. The USB port is configured to charge an accessory electronic device via the USB cable.

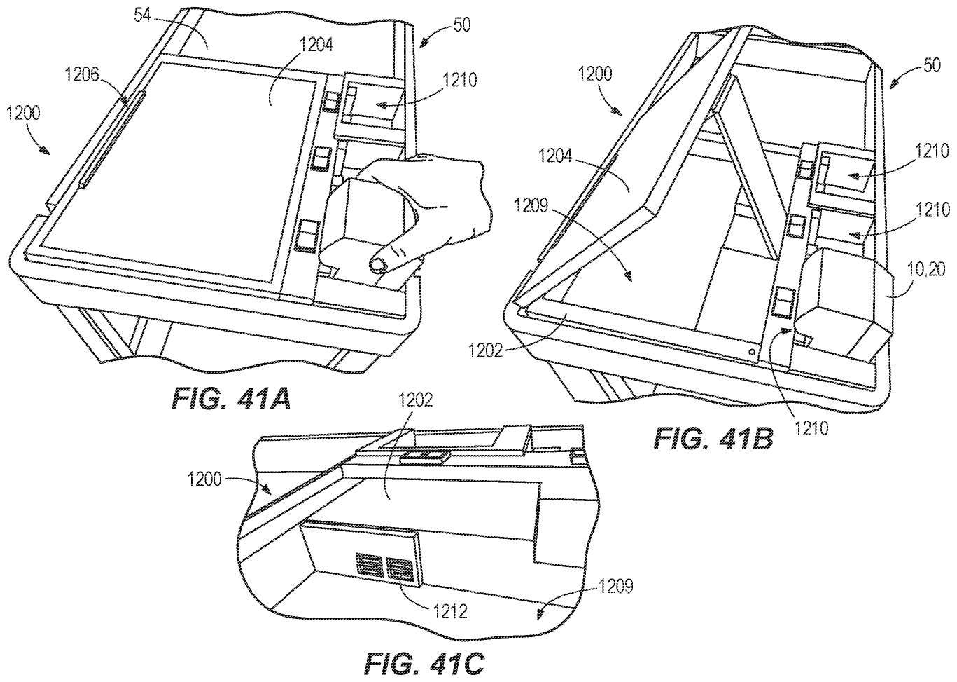

FIGS. 41A-41C illustrate charging module 1200 according to another embodiment of the disclosure. The charging module 1200 is adapted to be coupled to and/or supported on a mobile work cart such as the mobile work cart 50 (FIG. 5A). In the illustrated embodiment, the charging module 1200 is removably coupled to a top surface of the top shelf 1204 of the mobile work cart 50. The charging module 1200 includes a base 1202, a top shelf 1204 pivotable relative to the base 1202 about a hinge 1206, and an elongated stand 1208 pivotably coupled to the top shelf 1204. The top shelf 1204 defines a flat working surface. The top shelf 1204 is movable from a first position (FIG. 41A) and a second position (FIG. 41B). In the first position, the top shelf 1204 is resting flat on top of the base 1202 (e.g., such that the working surface is generally parallel relative to the base 1202). In the second position, the top shelf 1204 is pivoted away from the base 1202 about the hinge 1206 (e.g., such that the top shelf 1204 forms an oblique angle with the base 1202). When the top shelf 1204 is in the second position, the user may pivot the stand 1208 to a deployed position such that the stand 1208 extends between an upper edge of the top shelf 1204 and an edge of the base 1202 to hold the top shelf 1204 in the second position. Therefore, the stand 1208 maintains the top shelf 1204 in the second position. The top shelf 1204 may serve as a drafting table and/or easel for the user in either the first position or the second position. The base further defines a cavity or receptacle 1209 that can receive and store objects, such as tools, battery packs, personal devices, etc. The top shelf 1204 closes the receptacle 1209 in the first position and opens the receptacle 1209 in the second position.

With continued reference to FIGS. 41A-41C, the base 1202 can additionally include multiple charging bays 1210 for receiving at least one battery pack such as the battery packs 10, 20. The charging module 1200 can charge the battery packs 10, 20 when the battery packs are coupled to the charging bay 1210. In the illustrated embodiment, the base 1202 includes three charging bays 1210 each configured to receive the battery pack 20 (i.e., an 18-Volt battery pack). The base 1202 further includes at least one charging port. The illustrated charging port is a USB port 1212 for receiving a USB cable. The USB port 1212 is located adjacent the receptacle 1209. The USB port 1212 is configured to charge an accessory electronic device via the USB cable. While charging, the accessory electronic device an be stored within the receptacle 1209 and enclosed therein by the top shelf 1204.

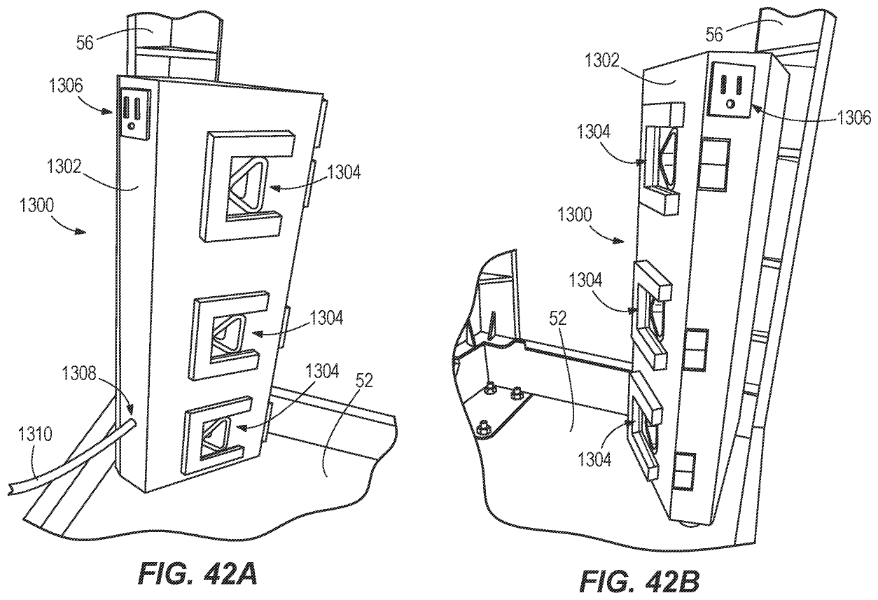

FIGS. 42A-42B illustrate a charging module 1300 according to another embodiment of the disclosure. The charging module 1300 is adapted to be coupled to and/or supported on a mobile work cart such as the mobile work cart 50 (FIG. 5A). The charging module 1300 can be removably mounted to the leg 56 of the mobile work cart 50. Specifically, the charging module 1300 is generally shaped as a triangular prism and fits in an inside corner of the leg 56 of the mobile work cart 50. The charging module 1300 includes a main body 1302 that includes a rear end shaped to fit within the inside corner of the leg 56, a front end, a first side, a second side, a bottom end, and a top end. The front end includes multiple charging bays 1304 for receiving at least one battery pack such as the battery packs 10, 20. The charging module 1300 can charge the battery packs 10, 20 when the battery packs are coupled to the charging bays 1304. In the illustrated embodiment, the front end includes three charging bays 1304 each configured to receive each of the battery packs 10, 20 (i.e., both a 12-Volt battery pack and an 18-Volt battery pack).

At least one of the sides of the charging module 1300 can include at least one port 1306. In the illustrated embodiment, both of the sides include a port 1306, and the ports are configured as AC pass-through ports 1306. The AC pass-through ports 1306 are connectable to tools and/or other equipment that have an AC power plug connector. In alternative embodiments, the charging module 1300 may include fewer or additional AC pass-through ports. The first side also includes an aperture 1308 extending therethrough. The aperture 1308 is shaped and sized to receive a power cord 1310 therethrough. Specifically, the aperture 1308 on the first side is positioned at a height which allows the exiting cord 1310 to clear the bottom lip 60 of the mobile work cart 50. This configuration reduces potential safety hazards for a user (e.g., tripping). In the illustrated embodiment, the cord 1310 is retractable and can be retracted through the aperture 1308 and into the main body 1302 when not in use. The bottom end of the main body 1302 includes multiple feet (not shown) mounted to a surface thereof. The feet rest against the lower shelf 52 and provide clearance between the bottom shelf 52 and the main body 1302.

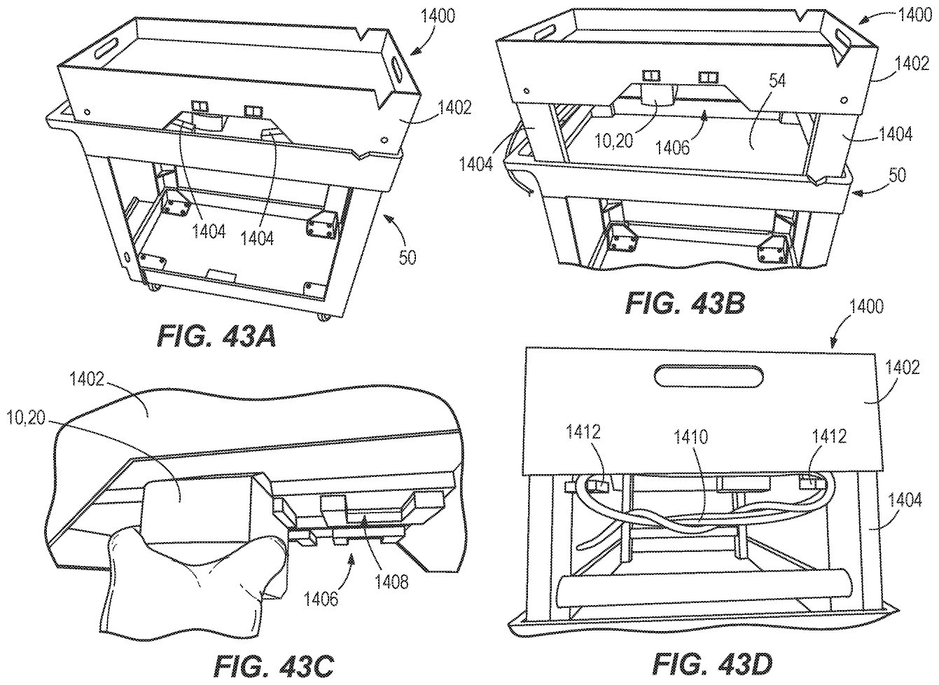

FIGS. 43A-43D illustrate a charging module 1400 according to another embodiment of the disclosure. The charging module 1400 is adapted to be coupled to and/or supported on a mobile work cart such as the mobile work cart 50 (FIG. 5A). The charging module 1400 is removably coupled to the upper shelf 54 of the mobile work cart. The charging module 1400 includes a base 1402 and legs 1404 pivotably coupled to an underside of the base 1402. With continued reference to FIG. 4, a cavity 1406 is formed in a portion of the underside of the base 1402. The base 1402 includes multiple charging bays 1408 for receiving at least one battery pack such as the battery packs 10, 20. The charging module 1400 can charge the battery packs 10, 20 when the battery packs are coupled to the charging bays 1408. In the illustrated embodiment, the base 1402 includes four charging bays 1408 each configured to receive each of the battery packs 10, 20 (i.e., both a 12-Volt battery pack and an 18-Volt battery pack). When the battery packs 10, 20 are coupled to the charging bays 1408, the battery packs 10, 20 are received at least partially within the cavity 1406

The legs 1404 are coupled to the underside of the base 1402 and are movable between a stowed position (FIG. 43A) and a working position (FIG. 43B). In the illustrated embodiment, the charging module 1400 includes two legs 1404, each of which is positioned on an opposite end of the base 1402. When the legs 1404 are pivoted to the working position, a storage space is revealed on the upper shelf 54 and under the base 1402 for a user to store tools, cords, accessories, etc. The storage space additionally provides room for a user to attach and detach the battery packs 10, 20 from the charging bays 1408. In some embodiments, the charging module 1400 may further include a cord management system coupled to the underside of the base 1402 for organizing and storing a power cord 1410. The cord management system includes two opposed protrusions 1412 (FIG. 43D) about which the power cord 1410 may be wrapped.

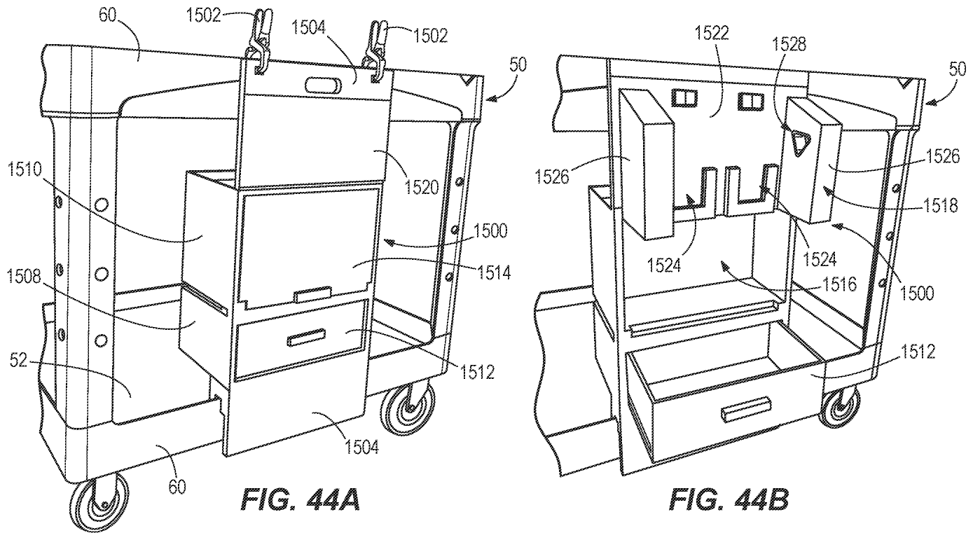

FIGS. 44A and 44B illustrate a charging module 1500 according to another embodiment of the disclosure. The charging module 1500 is adapted to be coupled to and/or supported on a mobile work cart such as the mobile work cart 50 (FIG. 5A). The charging module 1500 is removably coupled to a side of the mobile work cart 50. Specifically, a lower end of the charging module 1500 can engage the lip 60 of the lower shelf 52, and the charging module 1500 can include quick-grip clamps 1502 for removably coupling an upper end of the charging module 1500 to the lip 60 of the upper shelf 54. The charging module 1500 is sized to be relatively compact. Therefore, the charging module 1500 does not block the sides of the cart and can be accessed from multiple directions while coupled to the work cart 50. The charging module 1500 includes a first connection portion 1504, a second connection portion 1506, a first storage compartment 1508, and a second storage compartment 1510. The first and second storage compartments 1508, 1510 are positioned between the first connection portion 1504 and the second connection portion 1506. The first and second connection portions 1504, 1506 are generally planar and formed at the lower and upper ends of the charging module 1500, respectively, and are configured to be coupled to the lower and upper shelves 52, 54 of the mobile work cart 50 as explained above.

The first storage compartment 1508 includes a retractable drawer 1512 shaped and sized to receive tools, accessories, etc. The second storage compartment 1510 is positioned above the first storage compartment 1508 and includes and pivotable door 1514. The second storage compartment 1510 includes a chamber 1516 for providing additional storage. An inner side of the door 1514 includes a charging unit 1518, as will be described in more detail below.

With continued reference to FIG. 44A-44B, a magnetic strip 1520 is coupled to the second connection portion 1506. The door 1514 is configured to magnetically couple to the magnetic strip 1520 when the door 1514 is opened to thereby hold the door 1514 in the open position revealing the charging unit 1518 and the chamber 1516. When the door 1514 is closed, the charging unit 1518 is stored within the chamber 1516. The charging unit 1518 includes a base 1522 having charging bays 1524 and protective bumpers 1526 coupled to the base 1522. The base 1522 includes multiple charging bays 1524 for receiving at least one battery pack such as the battery packs 10, 20. The charging module 1500 can charge the battery packs 10, 20 when the battery packs are coupled to the charging bays 1524. In the illustrated embodiment, the base 1522 includes two charging bays 1524 each configured to receive each of the battery packs 10, 20 (i.e., both a 12-Volt battery pack and an 18-Volt battery pack). However, in alternative embodiments, the base 1522 may include fewer or additional charging bays. The bumpers 1526 extend from the base 1522 to protect the battery packs 10, 20 coupled to the charging bays 1524. In the illustrated embodiment, each bumper 1526 includes an additional charging bay 1528 configured to receive the battery pack 10 (i.e., a 12-Volt battery pack).

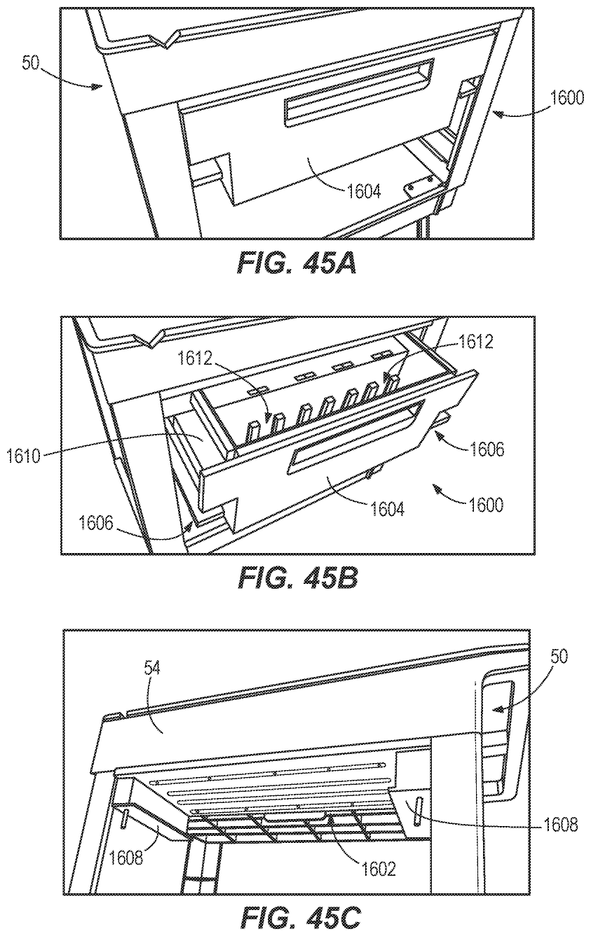

FIGS. 45A-45C illustrate a charging module 1600 according to another embodiment of the disclosure. The charging module 1600 is adapted to be coupled to and/or supported on a mobile work cart such as the mobile work cart 50 (FIG. 5A). The charging module 1600 is removably coupled to an underside of the upper shelf 54 of the mobile work cart 50. The charging module 1600 may also be decoupled from the mobile work cart 50 and used as a standalone unit. The charging module 1600 includes a base 1602 and a retractable drawer 1604 movable into and out of the base 1602. The base 1602 includes multiple slots formed in a top side thereof. To couple the base 1602 to the cart 50, the slots are aligned with ribs on the underside of the upper shelf 54 of the mobile work cart 50, and fasteners are inserted through the slots and fastened to the ribs. The slots on the base 1602 allow the charging module 1600 to be installed on carts of various shapes and sizes. Specifically, the base 1602 is fully enclosed under the top shelf 54 of the cart 50.

The drawer 1604 includes two channels 1606 corresponding to rails 1608 on the base 1602. In order to slide the drawer 1604 relative to the base 1602, the user aligns the channels 1606 with the rails 1608 and slides the drawer 1604 into and out of the base 1602. The channels 1606 on the drawer 1604 additionally include side locks 1610 to allow and/or prevent the user from fully removing the drawer 1604 from the base 1602. The drawer 1604 includes multiple charging bays 1612 for receiving at least one battery pack such as the battery packs 10, 20. The charging module 1600 can charge the battery packs 10, 20 when the battery packs are coupled to the charging bays 1612. In the illustrated embodiment, the drawer 1604 includes four charging bays 1612 each configured to receive each of the battery packs 10, 20 (i.e., both a 12-Volt battery pack and an 18-Volt battery pack). The charging module 1600 additionally includes at least one side lock configured to lock the drawer 1604 in a closed position.

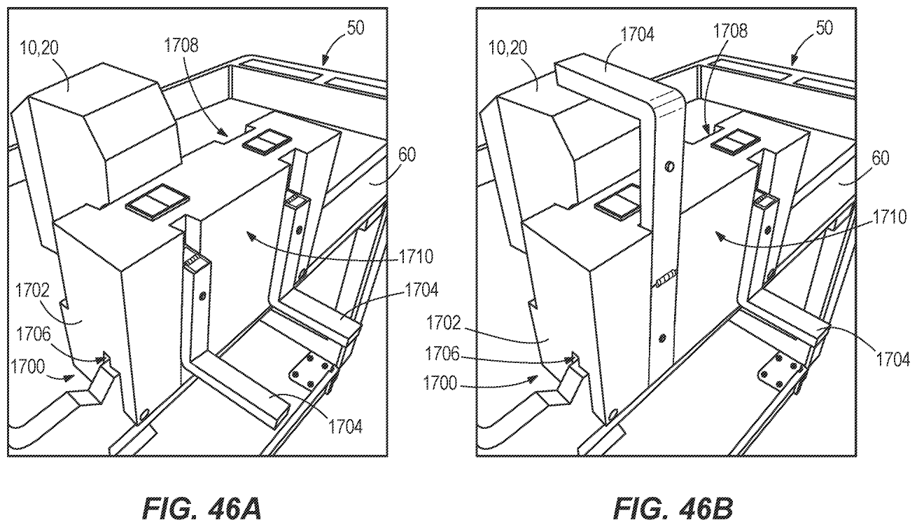

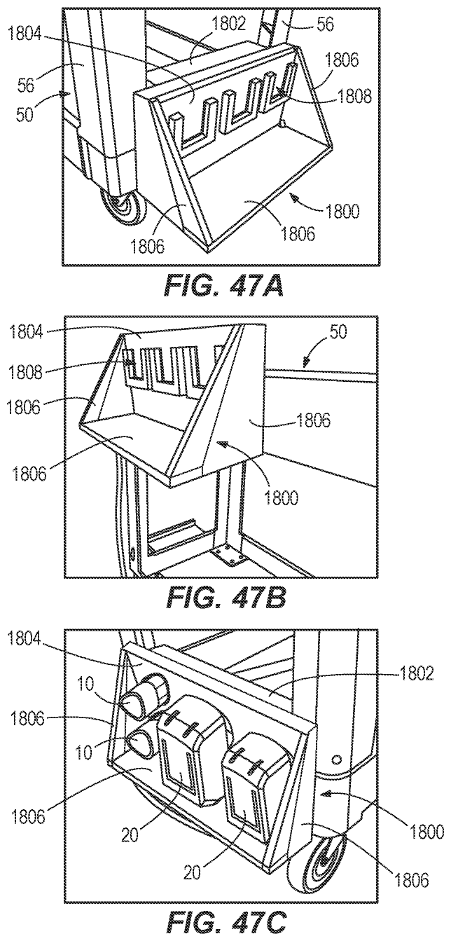

FIGS. 46A-46B illustrate a charging module 1700 according to another embodiment of the disclosure. The charging module 1700 is adapted to be coupled to and/or supported on a mobile work cart such as the mobile work cart 50 (FIG. 5A). The charging module 1700 can be removably coupled to the lip 60 of the upper shelf 54 of the mobile work cart 50. The charging module 1700 includes a base 1702 and L-shaped arms 1704 pivotably coupled to the base 1702. A slot or channel 1706 extends through at least a portion of the base 1702. The lip 60 of the upper shelf 54 is received within the channel 1706 when the charging module 1700 is mounted on the cart 50. Fasteners (e.g., screws) may additionally be used to secure the charging module 1700 to the mobile work cart 50. An upper end of the base 1702 includes multiple charging bays 1708 for receiving at least one battery pack such as the battery packs 10, 20. The charging module 1700 can charge the battery packs 10, 20 when the battery packs are coupled to the charging bays 1708. In the illustrated embodiment, the base 1702 includes two charging bays 1708 each configured to receive each of the battery packs 10, 20 (i.e., both a 12-Volt battery pack and an 18-Volt battery pack). However, the base 1702 may include fewer or additional charging bays.

The arms 1704 are pivotable between a first, deployed position, and a second, locked position. When the arms 1704 are in the first position, they extend laterally away from the base 1702 and serve as storage hooks. The user may store (e.g., hang) various items on the arms 1704 when they are in the first position. When the arms 1704 are pivoted to the second position, the arms 1704 engage the battery pack 10, 20 positioned in the charging bay 1708, thereby locking the battery pack 10, 20 in position on the charging bay 1708. When the arm 1704 is in the second position, the user is unable to remove the battery pack 10, 20 from the charging bay 1708. In some embodiments, the base 1702 may include a lock mechanism 1710 to secure the arms 1704 in the second position.

FIGS. 47A-47C illustrate a charging module 1800 according to another embodiment of the disclosure. The charging module 1800 is adapted to be coupled to and/or supported on a mobile work cart such as the mobile work cart 50 (FIG. 5A). The charging module 1800 can removably couple to the lip 60 of the lower shelf 52 or to the lip 60 of the upper shelf 52, at any of the lateral sides or the longitudinal ends of the mobile work cart 50. The charging module 1800 includes a base 1802 having a slot (not shown) for receiving the lip 60, a mounting plate 1804 adjacent the base 1802, and side plates or bumpers 1806 oriented perpendicular to the mounting plate 1804 and extending away therefrom. The bumpers 1806 include two side bumpers 1806 that are generally triangular or wedge-shaped, and a bottom bumper 1806 that is generally rectangular.

The mounting plate 1804 includes multiple charging bays 1808 for receiving at least one battery pack such as the battery packs 10, 20. The charging module 1800 can charge the battery packs 10, 20 when the battery packs are coupled to the charging bays 1808. In the embodiment of FIGS. 47A and 47B, the mounting plate 1804 includes three charging bays 1808 each configured to receive the battery pack 20 (i.e., an 18-Volt battery pack). In the embodiment of FIG. 47C, the mounting plate 1804 includes two charging bays 1808 configured to receive the battery pack 20 and two additional charging bays 1808 configured to receive the battery pack 10 (i.e., a 12-Volt battery pack).

Exposed surfaces of the bumpers 1806 may be padded or otherwise impact-resistant to protect the battery packs 10, 20 from impact. The charging module 1800 additionally includes a cord management system, thereby allowing a user to wrap an extension cord around the charging module 1800 for compact storage.

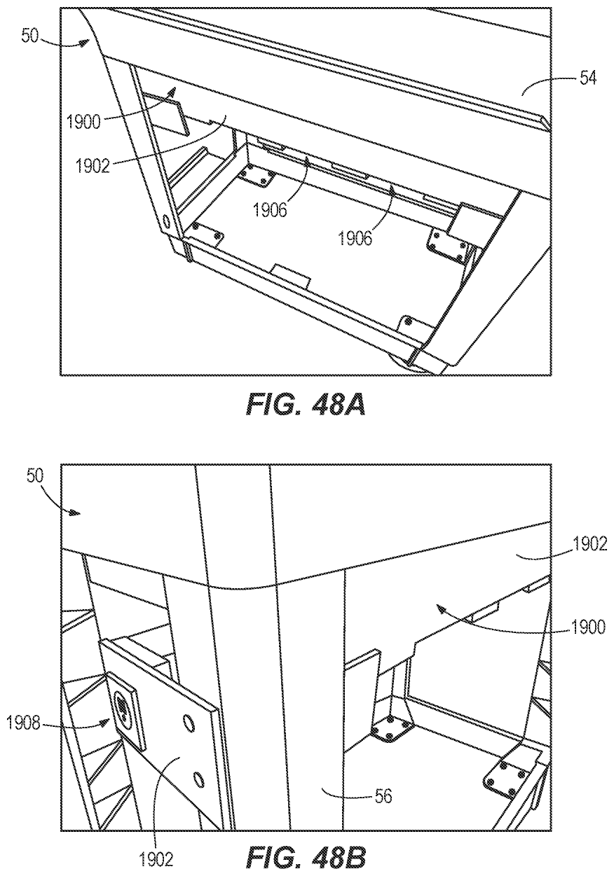

FIGS. 48A and 48B illustrate a charging module 1900 according to another embodiment of the disclosure. The charging module 1900 is adapted to be coupled to and/or supported on a mobile work cart such as the mobile work cart 50 (FIG. 5A). The charging module 1900 can be removably coupled to an underside (e.g., within a negative space) of the upper shelf 54 of the mobile work cart 50. The charging module 1900 includes a generally rectangular base 1902 and planar arms 1904 extending from the base 1902. The arms 1904 can be attached to the legs 56 of the work cart 50 (e.g., via fasteners). Specifically, the charging module 1900 includes two arms 1904, each arm 1904 coupled to an opposite end of the base 1902. The base 1902 additionally includes multiple charging bays 1906 for receiving at least one battery pack such as the battery packs 10, 20. The charging module 1900 can charge the battery packs 10, 20 when the battery packs are coupled to the charging bays 1906.

The charging module 1900 additionally includes an on-board power bank supported within the base 1902. The power bank provides power (e.g., for charging the battery packs 10, 20) without the need for a power cord to supply power to the charging module 1900. At least one of the arms 1904 includes at least one charging port 1908. In the illustrated embodiment, the charging port 1908 is configured as an AC charging port 1908. The AC charging port 1908 can receive a power cord (i.e., a male plug of a power cord) that supplies power to recharge the power bank. Other suitable charging ports may also or alternatively be included on the charging module 1900.

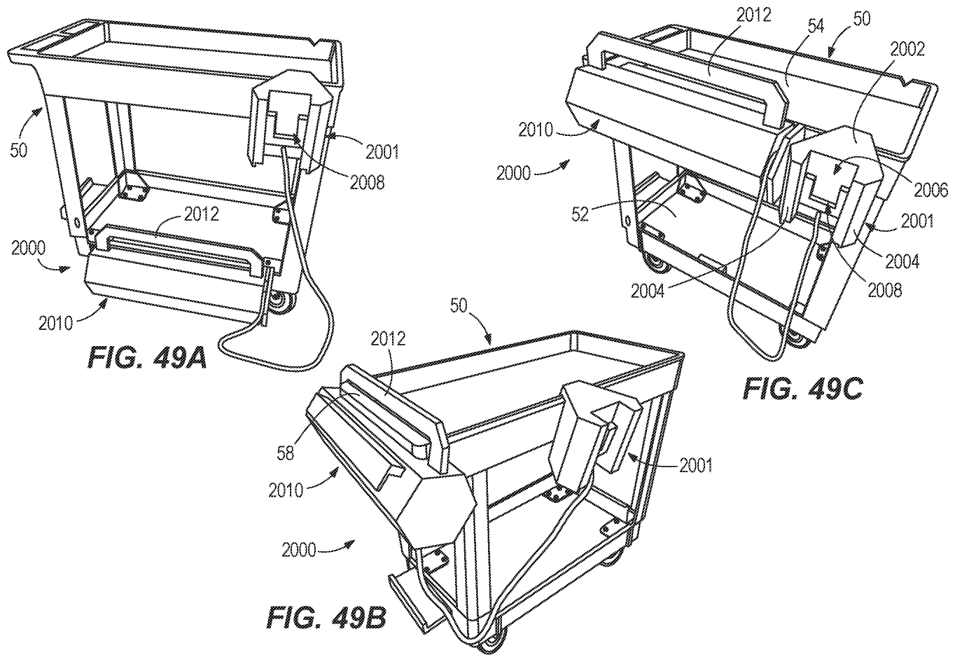

FIGS. 49A-49C illustrate a charging module 2000 according to another embodiment of the disclosure. The charging module 2000 is adapted to be coupled to and/or supported on a mobile work cart such as the mobile work cart 50 (FIG. 5A). The charging module 2000 an be removably coupled to a side or an end of the mobile work cart 50. In other words, the charging module 2000 may be coupled to the work cart 50 at multiple different locations. The charging module 2000 includes a charger 2001 having a base 2002 and two arms 2004. The base 2002 and the arms 2004 form a generally C-shaped channel 2006 for receiving a battery pack. Specifically, the base 2002 includes a single charging bay 2008 configured for receiving at least one battery pack such as the battery packs 10, 20. The charging module 2000 can charge the battery packs 10, 20 when the battery packs are coupled to the charging bay 2008. However, in alternative embodiments, the base may include additional (i.e., two or more) charging bays.

The charging module 2000 additionally includes a power bank 2010 electrically connected with the charger 2001 (e.g., via a power cord extending therebetween). The power bank 2010 includes a handle 2012, such that the power bank 2010 may be hung on the handle 58 of the work cart 50 by the handle 2012. Alternatively, the power bank 2010 may be mounted on the lip 60 and/or on the shelves 52, 54 of the mobile cart 50. The power bank 2010 may also be removed from the mobile cart 50 and used as a standalone unit. The power bank 2010 provides power to charge the battery pack 10, 20 coupled to the charger 2001.

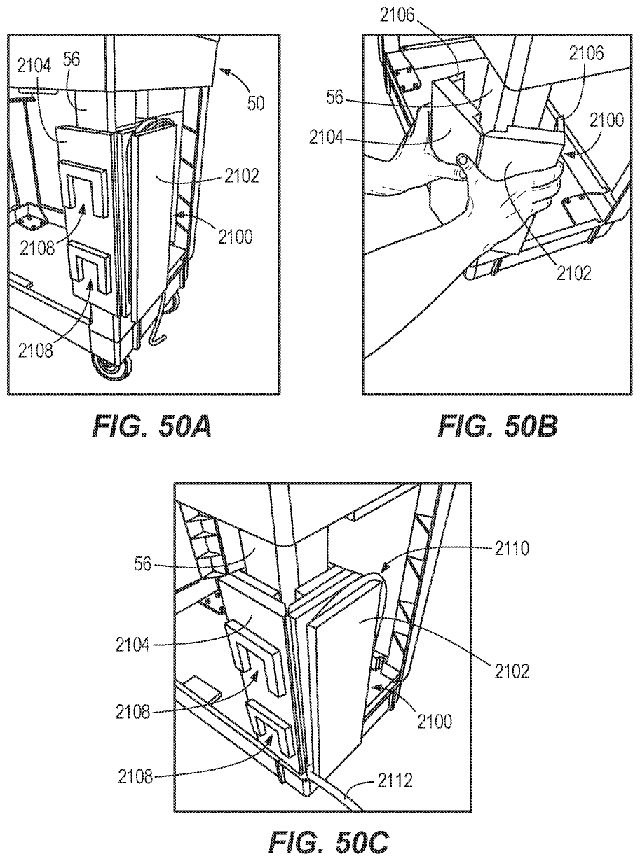

FIGS. 50A-50C illustrate a charging module 2100 according to another embodiment of the disclosure. The charging module 2100 is adapted to be coupled to and/or supported on a mobile work cart such as the mobile work cart 50 (FIG. 5A). The charging module 2100 is generally compact and does not take up any shelf space on the shelves 52, 54 of the work cart 50. The charging module 2100 includes a rectangular base 2102 and a rectangular charger body 2104 pivotably coupled to the base 2102. Each of the base 2102 and the charger body 2104 include a hook or flange 2106 extending along an end thereof and perpendicular to the base 2102 or the charger body 2104, respectively. The base 2102 and the charger body 2104 are shaped and sized to fit (e.g., clamp) around the leg 56 of the mobile work cart 50. In particular, the base 2102 and the charger body 2104 are sprung, meaning they are biased to pivot toward one another. To mount the charging module 2100 to the leg 56, the base 2102 and the charger body 2104 are pulled away from one another to increase a space between the flanges 2106, and the charging module 2100 is positioned about the leg 56. The charging module 2100 is then released, such that the base 2102 and the charger body 2104 pivot back toward one another and the flanges 2106 wrap around the edges of the leg 56 to grasp the leg.

The charger body 2104 includes charging bays 2108 configured for receiving at least one battery pack such as the battery packs 10, 20. The charging module 2100 can charge the battery packs 10, 20 when the battery packs are coupled to the charging bay 2108. In the illustrated embodiment, the charger body 2104 includes two charging bays 2108. However, in alternative embodiments, the charger body 2104 may include fewer or additional charging bays. With continued reference to FIGS. 50A-50C, the base 2102 additionally includes a cord wrap 2110 embodied as a slot extending about all four sides of the base 2102. A cord 2112 of the charging module 2100 can be wrapped around the cord wrap 2110 for compact storage.

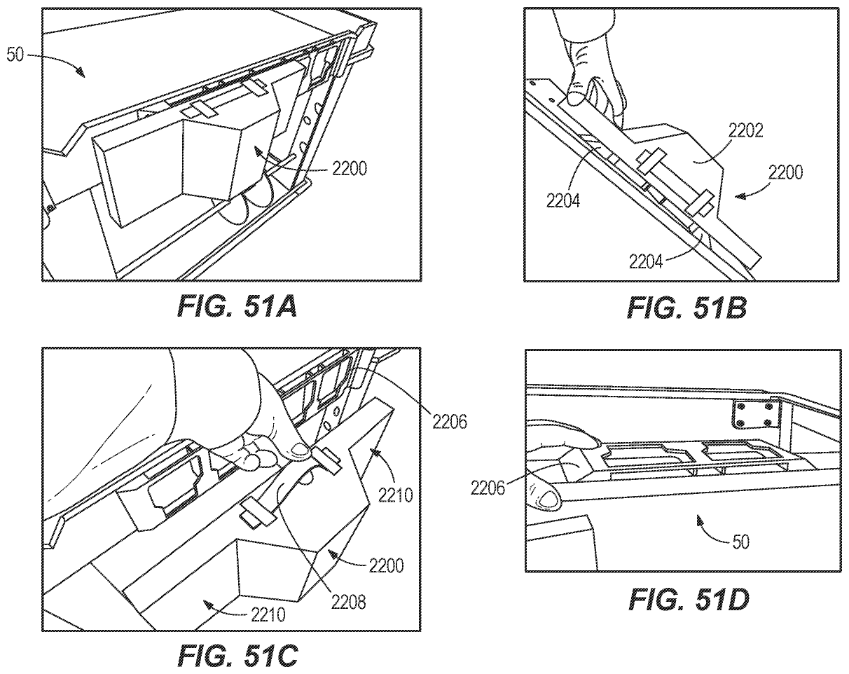

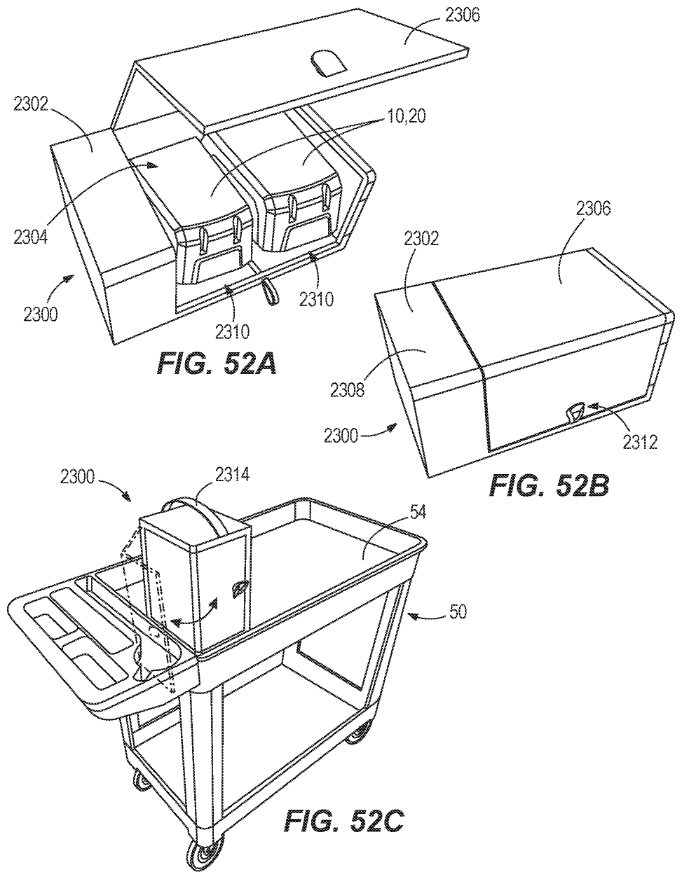

FIGS. 51A-51D illustrate a charging module 2200 according to another embodiment of the disclosure. The charging module 2200 is adapted to be coupled to and/or supported on a mobile work cart such as the mobile work cart 50 (FIG. 5A). The charging module 2200 is removably coupled to a side of the mobile work cart 50. The charging module 2200 includes a base 2202 having a set of cleats 2204 configured to mount onto an accessory mount plate 2206. The mount plate 2206 is configured to couple the charging module 2200 to the cart 50. An upper surface of the base 2202 includes a handle 2208 graspable by the user. The user may grasp the handle 2208 for support or when transporting the charging module 2200.

The base 2202 includes charging bays 2210 configured for receiving at least one battery pack such as the battery packs 10, 20. The charging module 2200 can charge the battery packs 10, 20 when the battery packs are coupled to the charging bay 2210. In the illustrated embodiments, the base 2202 includes two charging bays 2210 configured to receive the battery packs 10, 20 (i.e., 12-Volt and/or 18-Volt battery packs). However, in alternative embodiments, the base 2202 may include fewer or additional charging bays 2210. The base additionally includes a charging port (not shown). The charging port can be configured as an AC charging port, although other suitable charging ports may also or alternatively be included on the charging module 2200. The base 2202 may additionally include a cord wrap (not shown) which allows a user to wrap an extension cord thereabout for compact storage.

FIGS. 52A-52C illustrate a charging module 2300 according to another embodiment of the disclosure. The charging module 2300 is adapted to be coupled to and/or supported on a mobile work cart such as the mobile work cart 50 (FIG. 5A). The charging module 2300 is positionable on either of the shelves 52, 54 of the mobile work cart 50. The charging module 2300 includes a compact, rectangular base 2302 forming a storage chamber 2304 within, and a door 2306 pivotable relative to the base 2302. The charging module 2300 additionally includes an electronic block 2308 integrated within the base 2302. The base 2302 includes charging bays 2310 within the chamber 2304 configured for receiving at least one battery pack such as the battery packs 10, 20. The charging module 2300 can charge the battery packs 10, 20 when the battery packs are coupled to the charging bays 2310. In the illustrated embodiment, the base 2302 includes two charging bays 2310 configured to receive the battery packs 10, 20. However, in alternative embodiments, the base 2302 may include fewer or additional charging bays 2310.

The door 2306 is pivotable relative to the base 2302 between a first, closed position, and a second, open position. When the door 2306 is in the closed position, the battery packs 10, 20 are secured within the storage chamber 2304. When the door 2306 is in the open position, the user may access the storage chamber 2304 to remove the battery pack(s) 10, 20 from the chamber 2304 or connect the battery pack(s) 10, 20 to the charging bays 2310. The door 2306 additionally includes a latch 2312 configured to secure the door 2306 in the closed position. An upper end of the base 2302 includes a handle 2314 graspable by the user. The user may grasp the handle 2314 for support or when transporting the charging module 2300.

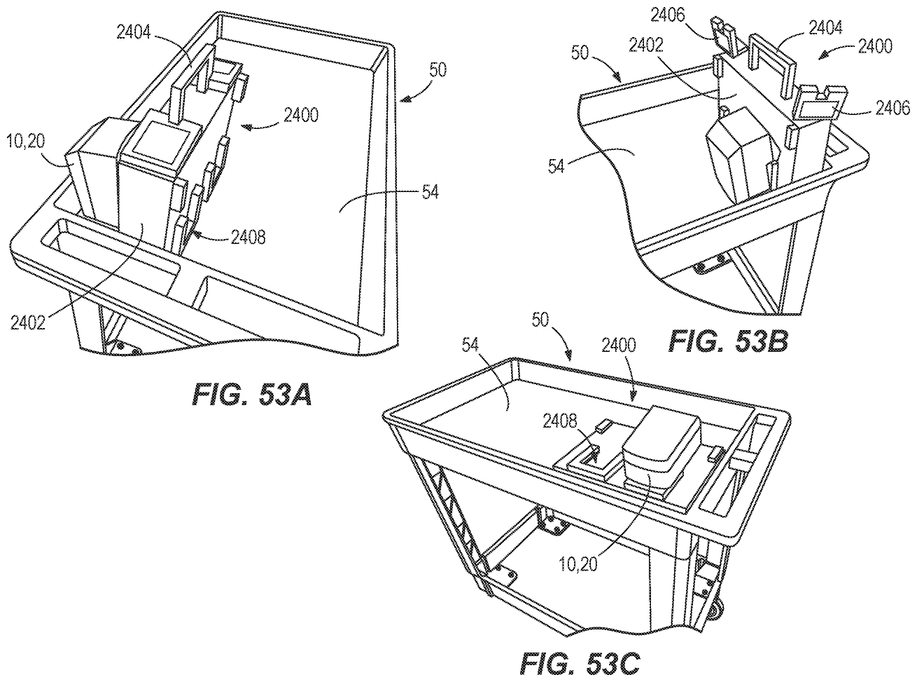

FIGS. 53A-53C illustrate a charging module 2400 according to another embodiment of the disclosure. The charging module 2400 is adapted to be coupled to and/or supported on a mobile work cart such as the mobile work cart 50 (FIG. 5A). The charging module 2400 is positionable on the upper shelf 54 of the mobile work cart 50. The charging module 2400 includes a planar base 2402. An end of the base 2402 includes a handle 2404 graspable by the user. The user may grasp the handle 2404 for support or when transporting the charging module 2400. The handle 2404 is pivotable relative to the base 2402. Specifically, the user may pivot the handle 2404 to a folded position for compact storage. The base 2402 additionally includes two lights 2406 pivotably coupled to the base 2402. Specifically, the base 2402 includes a first light 2406 coupled to a first end of the base 2402, and a second light 2406 coupled to a second end of the base 2402. The lights 2406 are configured to pivot, or swivel, relative to the base 2402 for a greater range of illumination.

The base 2402 includes charging bays 2408 configured for receiving at least one battery pack such as the battery packs 10, 20. The charging module 2400 can charge the battery packs 10, 20 when the battery packs are coupled to the charging bays 2408. Specifically, an upper end of the base 2402 includes two charging bays 2408, and a lower end of the base 2402 opposite the upper end includes an additional two charging bays 2408. If the charging module 2400 is supported on the cart 50 via the upper end or the lower end, then two charging bays 2408 are accessible by the user. However, if the charging module 2400 is supported on the cart via a side surface between the upper end and the lower end, then all four charging bays 2408 are accessible by the user. When the charging module 2400 is supported on the cart 50 via the side surface between the upper and lower ends, the battery packs 10, 20 contact the surface of the cart 50 to support the charging module 2400.

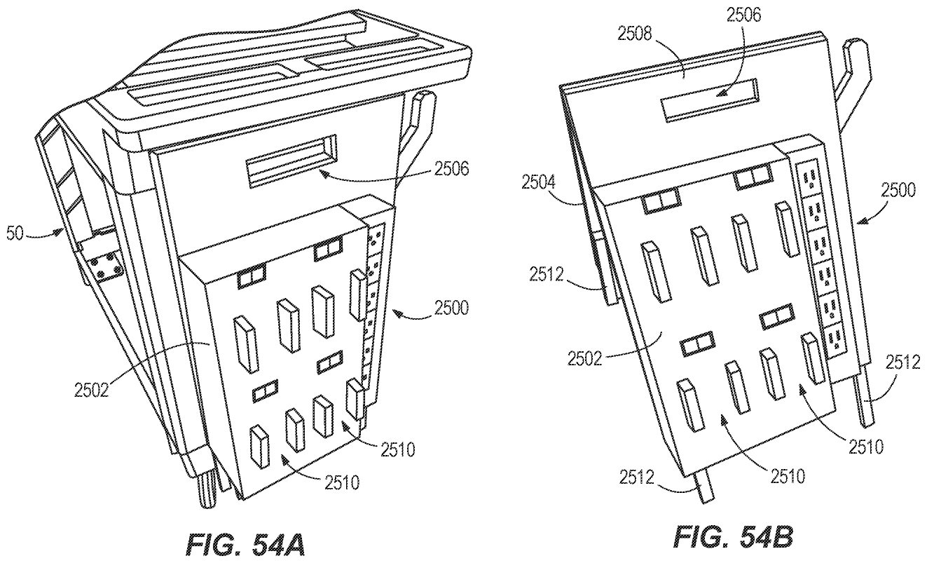

FIGS. 54A-54B illustrate a charging module 2500 according to another embodiment of the disclosure. The charging module 2500 is adapted to be coupled to and/or supported on a mobile work cart such as the mobile work cart 50 (FIG. 5A). The charging module 2500 is removably coupled to a side of the mobile work cart 50. Specifically, the charging module 2500 is shaped and sized to fit underneath the handle 58 of a mobile work cart 50. The charging module 2500 includes a base 2502 and a stand 2504 pivotable relative to the base 2502 about a hinge. The base 2502 and the stand 2504 are identically shaped and sized and the stand 2504 is configured to rest on top of the base 2502 when mounted to the work cart 50. An aperture 2506 extends through the base 2502 and the stand 2504, thereby forming a handle 2508 graspable by the user. The user may grasp the handle 2508 for support or when transporting the charging module 2500.

An exposed surface of the base 2502 includes charging bays 2510 configured for receiving at least one battery pack such as the battery packs 10, 20. The charging module 2500 can charge the battery packs 10, 20 when the battery packs are coupled to the charging bays 2510. Specifically, the base 2502 includes four charging bays 2510 configured to receive battery packs 10, 20. However, in alternative embodiments, the base 2502 may include fewer or additional charging bays 2510.

Distal ends of the base 2502 and the stand 2504 include legs 2512 extending therefrom and configured to support the charging module 2500 on the ground. Specifically, when the charging module 2500 is removed from the work cart 50, the user may pivot the stand 2504 away from the base 2502 and position the legs 2512 on the ground to support the charging module 2500 in an upright, self-supporting position.

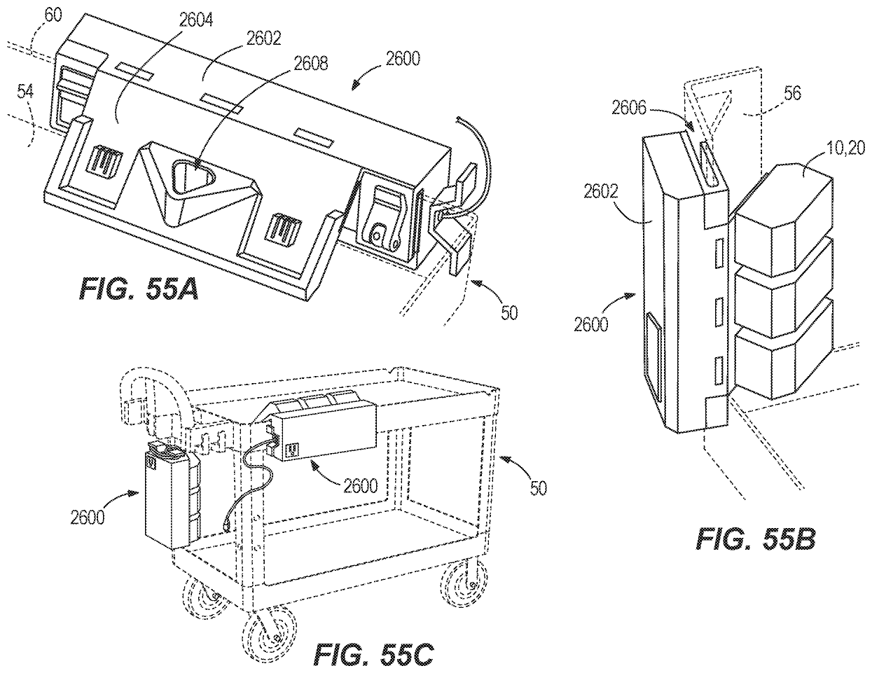

FIGS. 55A-55C illustrate a charging module 2600 according to another embodiment of the disclosure. The charging module 2600 is adapted to be coupled to and/or supported on a mobile work cart such as the mobile work cart 50 (FIG. 5A). The charging module 2600 includes a base 2602 and a generally planer charging tray 2604 extending away from the base 2602 at an acute angle relative to the base 2602. The base 2602 includes a slot 2606 that can receive the lip 60 of the lower or upper shelves 52, 54 to secure the charging module 2600 to the work cart 50. The slot 2606 may also receive a portion of the leg 56 of the work cart 50 to secure the charging module 2600 to the leg 56.

The charging tray 2604 includes charging bays 2608 configured for receiving at least one battery pack such as the battery packs 10, 20. The charging module 2600 can charge the battery packs 10, 20 when the battery packs are coupled to the charging bays 2608. In the illustrated embodiment, charging tray 2604 includes three charging bays 2608, with two of the bays 2608 configured to receive the battery pack 20 (i.e., an 18-Volt battery pack) and one of the bays 2608 configured to receive the battery pack 10 (i.e., a 12-Volt battery pack). When the charging module 2600 is supported on the lip 60, the charging tray 2604 extends into an interior of the shelf 52, 54 so that the battery packs 10, 20 coupled thereto are protected within the footprint of the shelf. Similarly, when the charging module 2600 is supported on the leg 56, the charging tray 2604 extends toward an interior of the work cart 50 such that the battery packs 10, 20 coupled thereto are protected within the footprint of the work cart 50. The charging module 2600 further includes a cord wrap 2610 about which a cord 2612 of the charging module 2600 can be wound.

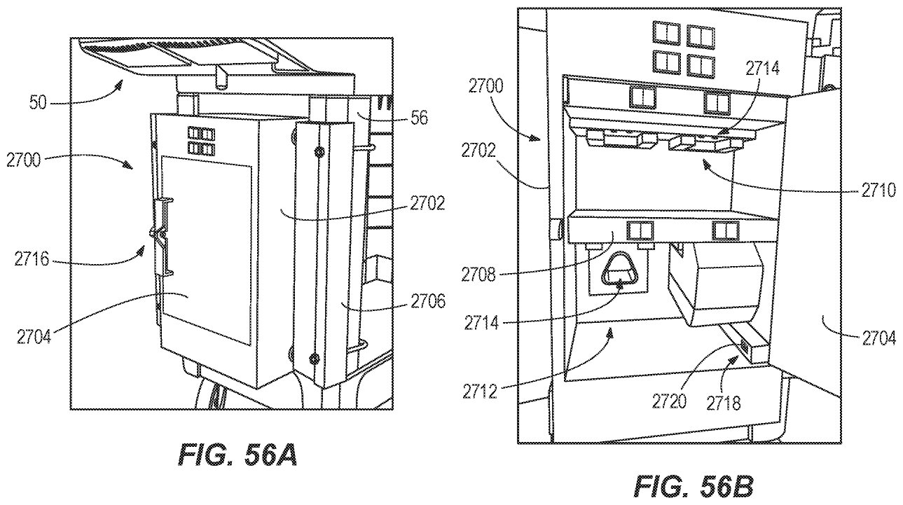

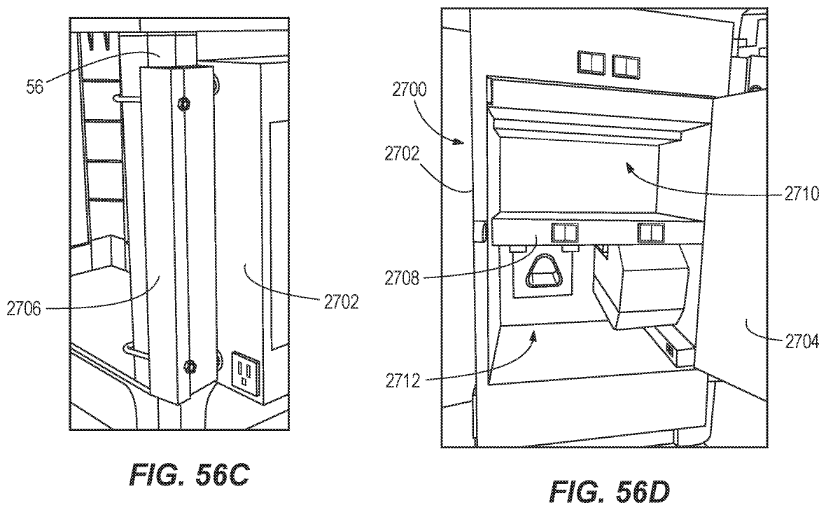

FIGS. 56A-56D illustrate a charging module 2700 according to another embodiment of the disclosure. The charging module 2700 is adapted to be coupled to and/or supported on a mobile work cart such as the mobile work cart 50 (FIG. 5A). The charging module 2700 is configured as a cabinet and includes a rectangular case 2702 defining a compartment therein, a door 2704, and mounting flanges 2706 extending from each lateral side of the case 2702. The mounting flanges 2706 can be secured to two legs 56 of the work cart 50 via fasteners such as, e.g., screws, U-bolts, and the like.

The charging module 2700 includes a shelf 2708 supported within the case 2702 and dividing the compartment into an upper compartment 2710 and a lower compartment 2712. The charging module 2700 further includes charging bays 2714 configured for receiving at least one battery pack such as the battery packs 10, 20. The charging module 2700 can charge the battery packs 10, 20 when the battery packs are coupled to the charging bays 2714. In the embodiment of FIGS. 56A-56C, two charging bays 2714 are formed on the case 2702 facing toward the upper compartment 2710, and two charging bays 2714 are formed on the shelf 2708 facing toward the lower compartment 2712. When the battery packs 10, 20 are coupled to the charging bays 2714, the battery packs reside within the upper and lower compartments 2710, 2712. The door 2704 can be closed to secure the battery packs 10, 20 within the compartments 2710, 2712. The charging module 2700 further includes a lock mechanism 2716 operable to lock the door 2704 in the closed position. The charging module 2700 further includes a USB port module 2718 that includes multiple USB ports 2720 for receiving a USB cable. The USB ports 2720 are configured to charge an accessory electronic device via the USB cable.

In the embodiment of FIG. 56D, the charging module 2700 includes only two charging bays 2714 formed on the shelf 2708 and facing toward the lower compartment 2712. Thus, the upper compartment 2710 can be used for general storage purposes. In each of the embodiments of FIGS. 56A-56D, the charging module 2700 can further include a heating element (not shown) located in a bottom region of the case 2702 for warming the battery packs 10, 20 when ambient temperatures are cold.

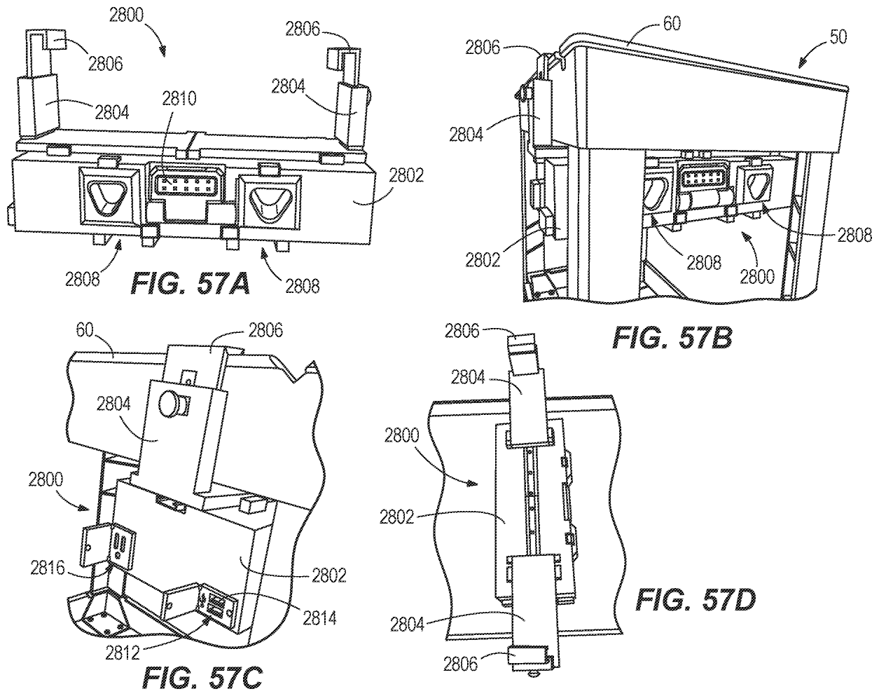

FIGS. 57A-57D illustrate a charging module 2800 according to another embodiment of the disclosure. The charging module 2800 is adapted to be coupled to and/or supported on a mobile work cart such as the mobile work cart 50 (FIG. 5A). The charging module 2800 includes an elongated rectangular base 2802 and a pair of legs 2804 coupled to the base 2802 and extending upward therefrom. The legs 2804 include hooks 2806 formed at distal ends thereof. The charging module 2800 can be mounted to the work cart 50 with the base 2802 residing in the space beneath the upper shelf 54 and the hooks 2806 of the legs 2804 engaging the lip 60 of the upper shelf 54 to hold the charging module 2800 on the work cart 50. In some embodiments, the legs 2804 can be slidable relative to the base 2802 along a longitudinal direction of the base 2802, so that the hooks 2806 can be adjusted to fit work carts of different sizes.

The charging module 2800 includes two charging bays 2808 located on a lateral side of the base 2802 and configured for receiving at least one battery pack such as the battery packs 10, 20. The charging module 2800 can charge the battery packs 10, 20 when the battery packs are coupled to the charging bays 2808. The charging module 2800 also includes a work light 2810 positioned between the charging bays 2808. The work light 2810 is operable to illuminate a space in front of the work cart 50. The charging module 2800 further includes a USB port module 2812 that includes multiple USB ports 2814 for receiving a USB cable. The USB ports 2814 are configured to charge an accessory electronic device via the USB cable. The charging module 2800 further includes an AC pass-through port 2816 located an end of the base 2802. The AC pass-through port 2816 is connectable to tools and/or other equipment that have an AC power plug connector to supply AC power thereto. The charging module 2800 further includes a male AC port (not shown) for connecting to a power cord (not shown) to supply power to the charging module 2800.

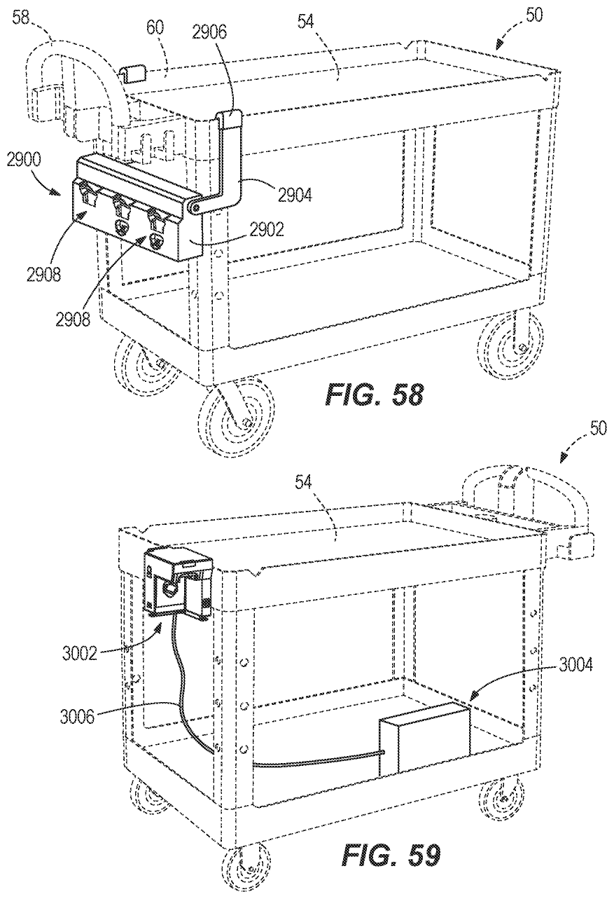

FIG. 58 illustrates a charging module 2900 according to another embodiment of the disclosure. The charging module 2900 is adapted to be coupled to and/or supported on a mobile work cart such as the mobile work cart 50 (FIG. 5A). The charging module 2900 includes an elongated rectangular base 2902 and a pair of legs 2904 coupled to the base 2902 and extending away therefrom. Each leg 2904 includes a laterally extending portion, a vertically extending portion, a hook 2906 formed at a distal end of the vertically extending portion. The charging module 2900 can be mounted to the front of the work cart 50 with the base 2902 residing in the space beneath the handle 58 and the hooks 2906 engaging the lip 60 of the upper shelf 54.

The charging module 2900 includes three charging bays 2908 located on a lateral side of the base 2902 and configured for receiving at least one battery pack such as the battery packs 10, 20. The charging module 2900 can charge the battery packs 10, 20 when the battery packs are coupled to the charging bays 2908. The charging module 2900 further includes a USB port module (not shown) that includes multiple USB ports (not shown) for receiving a USB cable. The USB ports are configured to charge an accessory electronic device via the USB cable. The charging module 2900 further includes an AC pass-through port (not shown) located an end of the base 2902. The AC pass-through port is connectable to tools and/or other equipment that have an AC power plug connector to supply AC power thereto. The charging module 2900 further includes a male AC port (not shown) for connecting to a power cord (not shown) to supply power to the charging module 2900.

FIG. 59 illustrates a charging module 3000 according to another embodiment of the disclosure. The charging module 3000 is adapted to be coupled to and/or supported on a mobile work cart such as the mobile work cart 50 (FIG. 5A). The charging module 3000 includes a charger 3002 and a power bank 3004 electrically connected to the charger 3002 via a power cord 3006. In the illustrated embodiment, the charger 3002 is substantially similar to the charging module 200 described above, except that the charger 3002 is powered by the power bank 3004. The charging module 3000 can be supported entirely on the work cart 50 and eliminates the need for a power cord extending away from the work cart 50.

Various features of the disclosure are set forth in the following claims.

What is claimed is:

1. A charging module configured to be removably coupled to a mobile work cart, the charging module comprising:
a housing having a first end, a second end opposite the first end, a front side, and a rear side opposite the front side, the housing defining a cavity in at least the front side, the housing further including a charging bay located within the cavity, the charging bay being configured to removably receive a battery pack to electrically connect the battery pack to the charging module;
a clamp coupled to the rear side of the housing, the clamp including a handle portion and an arm, the clamp being movable relative to the housing along a direction toward or away from the rear side between a deployed position and a retracted position, the clamp being biased toward the retracted position;
wherein in the housing defines a recess in the rear side, and wherein when the clamp is in the retracted position the arm is received within the recess.

2. The charging module of claim 1, further comprising a task light pivotably coupled to the housing at the first end.

3. The charging module of claim 2, wherein the charging module is configured to supply power to the battery pack to recharge the battery pack in a first mode, and wherein the charging module is configured to draw power from the battery pack to activate the task light in a second mode.

4. The charging module of claim 1, further comprising a permanent magnet affixed to the rear side of the housing.

5. The charging module of claim 1, wherein the charging bay comprises a first battery receptacle and a second battery receptacle, wherein the battery pack is a battery pack of a first type, wherein the first battery receptacle is configured to removably receive the battery pack of the first type, and wherein the second battery receptacle is configured to receive a battery pack of a second type different from the first type.

6. The charging module of claim 1, wherein the arm is a first arm and the clamp further comprises a second arm, each arm being located at an opposite end of the handle portion and extending perpendicular to the handle portion and parallel to each other.

7. The charging module of claim 1, wherein the charging bay is a first charging bay and wherein the charging module further comprises a second charging bay located within the cavity adjacent the first charging bay.

8. The charging module of claim 1, further comprising a Universal Synchronous Bus (USB) port positioned in the front side of the housing.

9. A charging module configured to be removably coupled to a mobile work cart, the charging module comprising:
a case defining a chamber and an opening communicating with the chamber;
a door coupled to the case and movable between a closed position enclosing the chamber and an open position permitting access to the chamber via the opening;
a shelf pivotably coupled to the case and supported within the chamber, the shelf being pivotable relative to the case between a retracted position away from the opening and a deployed position extending toward the opening;
a charging bay supported on the shelf, the charging bay being configured to removably receive a battery pack to electrically connect the battery pack to the charging module.

10. The charging module of claim 9, wherein the door includes a tab provided on an inner surface thereof, and wherein when the door is in the closed position the tab engages the shelf to pivot the shelf to the retracted position.

11. The charging module of claim 9, wherein the shelf is a first shelf, and wherein the charging module further includes a second shelf pivotably coupled to the case and supported within the chamber.

12. The charging module of claim 9, further including a lock mechanism configured to secure the door in the closed position.

13. A charging module configured to be removably coupled to a mounting plate having a plurality of cleat receptacles, the charging module comprising:
a housing having a first end, a second end opposite the first end, a front side, a rear side opposite the front side, a bottom side, and a top side opposite the bottom side, the housing defining a handle at the first end, the housing including a plurality of cleats formed on the bottom side and configured to insert into the plurality of cleat receptacles of the mounting plate;
a plurality of charging bays located at the top side of the housing, each charging bay being configured to removably receive a battery pack to electrically connect the battery pack to the charging module; and
a male AC port supported on the housing.

14. The charging module of claim 13, further comprising a lock plate configured to releasably couple to the front side of the housing, wherein when the battery pack is coupled to a first charging bay of the plurality of charging bays and the lock plate is coupled to the front side of the housing, the lock plate prevents removal of the battery pack from the first charging bay.

15. The charging module of claim 14, wherein the housing includes a lock tab and the lock plate includes a lock aperture that receives the lock tab when the lock plate is coupled to the front side of the housing.

16. The charging module of claim 14, wherein the lock plate is slidably connected to the housing by a slide rail.

17. The charging module of claim 13, wherein a first charging bay of the plurality of charging bays comprises a first battery receptacle and a second battery receptacle, wherein the battery pack is a battery pack of a first type, wherein the first battery receptacle is configured to removably receive the battery pack of the first type, and wherein the second battery receptacle is configured to receive a battery pack of a second type different from the first type.

18. The charging module of claim 13, further comprising a Universal Synchronous Bus (USB) port positioned in the second end of the housing.

19. The charging module of claim 13, further comprising a cover releasably attachable to the housing, wherein the cover covers the plurality of charging bays when the cover is attached to the housing.

20. The charging module of claim 19, wherein the cover includes a plurality of recesses defined in a surface thereof, the plurality of recesses being configured to receive the plurality of cleats of a second charging module.
